(19) United States
(12) Patent Application Publication
(10) Pub. No.: US 2021/0279756 A1
(43) Pub. Date: Sep. 9, 2021

(54) SYSTEM FOR DYNAMICALLY OPTIMIZING THE INCOME OF A SERVICE PROVIDER

(71) Applicant: Adrian Alanis Lopez, Mexico City (MX)

(72) Inventor: Adrian Alanis Lopez, Mexico City (MX)

(21) Appl. No.: 16/808,024

(22) Filed: Mar. 3, 2020

(51) Int. Cl. G06Q 30/02; G06Q 30/06; G06Q 20/28

(52) U.S. Cl. CPC G06Q 30/0222; G06Q 20/28; G06Q 30/0641; G06Q 30/0235

(57) ABSTRACT

A computer program product provides for the operations of a dynamic income optimization system that interfaces with both service provider computing devices and customer computing devices. The operations may comprise receiving an allotment of services available at a discount from a plurality of service providers. The operations may further comprise receiving a query identifying a targeted parameter describing a targeted service from a customer computing device. The operations provide a graphical user interface for displaying information about service providers matching the query, such information including discounts provided in an allotment of services. The operation may further include receiving input from the customer computing device selecting a service provider and initiating a transaction such as purchasing a voucher or funding a prepaid account.

### BACKGROUND

The present disclosure relates to a computing system that enables a customer to select and purchase a service at a discount.

### BACKGROUND OF THE RELATED ART

Many developed economies have a large and active services sector. Businesses that are involved in the service sector perform activities at the request of customers. Some businesses may provide services to customers with no accompanying transfer of goods, while other businesses may provide services in some combination with a transfer of goods. Still, any business that provides a service in the normal course of business may be considered to be a service business.

Businesses that make and sell a product without any particular interaction with the end-user or customer, such as a furniture manufacturer, may be almost exclusively providing goods. Businesses that provide no goods, such as a passenger airline, may be almost exclusively providing services. Other businesses that may provide a mix of goods and services may also be referred to as service providers, since they do in fact provide services. A restaurant is an example of a business that provides services in the form of a venue, ambience, setting and clearing tables, cooking, providing drink refills, and the like, while also providing goods in the form of prepared food.

Another distinction between goods and services is that goods may be available for sale at any given instant and, in some instance, may be returned if they are found to be unsatisfactory. By contrast, services typically require some amount of time to perform or deliver. The physical nature of goods allows them to be made at an efficient rate and stored until a customer buys the goods. However, services are typically rendered in real time and cannot be stored up. Therefore, a service provider must have the capacity to serve the customer when the customer demands the service. It is an unfortunate corollary that the service will have unused capacity in times when customer demand is low.

Service businesses may take various steps in an attempt to generate demand for their services so that they can make efficient use of their capacity. Such attempts may include advertising the services, offering promotional pricing, providing frequent customer rewards, and the like. While these marketing efforts may be more or less successful at increasing overall demand for the services of the business, many service providers still experience periods of high demand exceeding their capacity and other periods of low demand that are significantly below their capacity.

### BRIEF SUMMARY

Some embodiments provide a computer program product comprising a non-volatile computer readable medium and non-transitory program instructions embodied therein, the program instructions being configured to be executable by a processor to cause the processor to perform various operations. The operations may comprise receiving, from each of a plurality of service provider computing devices, an allotment of services available at a discount from a service provider, wherein the allotment of services identifies the name of the service provider, a parameter describing the services offered by the service provider, a price discount for the offered services, and a time period during which the price discount is applicable to receiving the offered services.

The operations may further comprise receiving, from a customer computing device, a query identifying a targeted parameter describing a targeted service, and transmitting, to the customer computing device, a graphical user interface for displaying the name of a service provider, from among the allotments of services received from the plurality of service provider computing devices, identified in one of the allotments of services in which the parameter describing offered services matches the targeted parameter of the targeted service.

The operations may still further comprise receiving input from the customer computing device identifying, from among the service providers displayed in the graphical user interface, a selected service provider and a selected time period during which a selected price discount is applicable to the provision of the offered services, wherein the input from the customer computing device further identifies the customer and a total prepaid purchase amount of the selected offered services to be prepaid by the customer or credited to the customer's prepaid account or wallet on the dynamic income optimization system. The operations may also comprise receiving a prepayment initiated from the customer computing device for the total prepaid purchase amount of the selected offered service less the selected price discount that is applicable to the provision of the selected offered services during the selected time period customer or crediting the customer's prepaid account or wallet on the dynamic income optimization system.

The operations may additionally comprise storing a voucher that identifies the customer, the selected service provider, the selected time period during which the selected price discount is applicable to the rendering of the selected offered services, and the total prepaid purchase amount of the selected offered services, customer or credited to the customer account or wallet on the dynamic income optimization system for which prepayment has been received, and transmitting a voucher notification to the service provider computing device of the selected service provider, wherein the voucher notification identifies the customer and the selected time period during which the selected price discount is applicable to the rendering of the selected offered services.

The operations may also comprise receiving an invoice from the service provider computing device of the selected service provider after the service provider has rendered services to the customer identified in the voucher notification, wherein the invoice identifies the service provider that rendered services to the customer, the customer, an actual purchase amount of the offered services, and a time at which the customer received the services; determining whether the service provider, the customer, and the time identified in the invoice match the service provider, the customer, and the time identified in the stored voucher; and initiating payment to the service provider in response to receiving the invoice and reaching a positive determination that the service provider, the customer, and the time identified in the invoice match the service provider, the customer, and the time identified in the stored voucher.

### BRIEF DESCRIPTION OF THE SEVERAL VIEWS OF THE DRAWINGS

FIG. 1 is a diagram of a system for managing discounted payment or prepayment of services for redemption at particular times.

FIG. 2 is a block diagram of program instruction modules for a dynamic income optimization system computing device.

FIG. 3 is a block diagram of program instruction modules for a service provider computing device.

FIG. 4 is a block diagram of program instruction modules for a customer computing device.

FIG. 5A is a process flow diagram illustrating a set of operations of the dynamic income optimization system computing device.

FIG. 5B is a process flow diagram illustrating interactions between a customer and a service provider, including operations of the customer computing device and the service provider computing device, as well as the dynamic income optimization system computing device.

FIG. 5C is a process flow diagram illustrating a further set of operations of the dynamic income optimization system computing device.

FIG. 6 is an illustration of the allotment records maintained by the dynamic income optimization system computing device.

FIG. 7 is an illustration of a graphical user interface generated by the dynamic income optimization system computing device for displaying a service query screen on a customer computing device.

FIG. 8 is an illustration of a graphical user interface generated by the dynamic income optimization system computing device for displaying a voucher purchase or credit to a customer account or wallet, screen on a customer computing device.

FIG. 9 is an illustration of a graphical user interface generated by the dynamic income optimization system computing device for displaying a voucher on a customer computing device.

FIG. 10 is an illustration of a voucher notification transmitted from the dynamic income optimization system computing device to the service provider computing device to identify a customer and the selected time period for which the customer has prepaid for services.

FIG. 11 is an illustration of a service provider guest receipt issued by the service provider computing device to the customer after service has been rendered and paid in full.

FIG. 12 is an illustration of an invoice received by the dynamic income optimization system computing device from the service provider computing device.

FIG. 13 is an illustration of a reconciliation statement generated by the dynamic income optimization system computing device and provided to the service provider to explain how a payment amount has been calculated.

FIG. 14 is an illustration of a graphical user interface generated by the dynamic income optimization system computing device for displaying a voucher purchase screen on a customer computing device or credit to the customer account or wallet on the dynamic income optimization system on a customer computing device.

FIG. 15 is an illustration of a graphical user interface generated by the dynamic income optimization system computing device for displaying a voucher on a customer computing device.

FIG. 16 is an illustration of a voucher notification transmitted from the dynamic income optimization system computing device to the service provider computing device to identify a customer and the selected time period for which the customer has prepaid for services or has scheduled a reservation.

FIG. 17 is an illustration of a service provider guest receipt issued by the service provider computing device to the customer after service has been rendered and paid in full.

FIG. 18 is an illustration of an invoice received by the dynamic income optimization system computing device from the service provider.

FIG. 19 is an illustration of a reconciliation statement generated by the dynamic income optimization system computing device and provided to the service provider computing device to explain how a payment amount has been calculated.

FIG. 20 is a diagram of a computing device that may form a short-range wireless connection with the communication network.

FIG. 21 is a diagram of one embodiment of a computing that may serve as the dynamic income optimization system computing device, the service provider computing device and/or the customer computing device.

FIG. 22 is an illustration of a graphical user interface generated by the dynamic income optimization system computing device for displaying a service query screen on a customer computing device according to a second embodiment.

FIG. 23 is an illustration of a graphical user interface generated by the dynamic income optimization system computing device for displaying a voucher purchase screen on a customer computing device or applying credit to the customer account or wallet on the dynamic income optimization system on a customer computing device according to a second embodiment.

FIG. 24 is an illustration of a graphical user interface generated by the dynamic income optimization system computing device for displaying a voucher on a customer computing device according to a second embodiment.

FIG. 25 is an illustration of a voucher notification transmitted from the dynamic income optimization system computing device to the service provider computing device according to a second embodiment.

FIG. 26 is an illustration of a graphical user interface generated by the dynamic income optimization system computing device for displaying on a customer computing device an estimated amount of money to load in the customer's wallet according to a second embodiment.

FIG. 27 is a flowchart of an embodiment of a method for modifying allotments of services among a plurality of discounts in order increase income for the service provider.

FIG. 28 is a flowchart of a sales or production tracking module.

FIGS. 29-32C provide an example of the performance of the method of FIG. 27 using specific values.

### DETAILED DESCRIPTION

Some embodiments provide a computer program product comprising a non-volatile computer readable medium and non-transitory program instructions embodied therein, the program instructions being configured to be executable by a processor to cause the processor to perform various operations. The processor may be a processor of a computer server (hereinafter simply “server”), a cluster of servers or other compute nodes, or a cloud computing service. Furthermore, the program instructions are configured to be executable by a processor and may, in fact, be executable by any number of processors in any one or more servers or compute nodes in any one or more locations. Accordingly, an instance of the program instructions may be executable by a single processor, executable across a plurality of processors, or executable by a series of different processors over time. In fact, the program instructions of the computer program product may be configured to be executable on any computing architecture that includes a processor capable of performing the operations. Some embodiments may refer to the computing system that executes the program instructions as being a dynamic income optimization system, discount voucher computing system and/or a prepaid discount computing system, and/or a discount system applying credit to a customer account or wallet on the dynamic income optimization system.

The operations may comprise or include receiving, from each of a plurality of service provider computing devices, an allotment of services available at a discount from a service provider, wherein the allotment of services identifies a price discount for the offered services, and a time period during which the price discount is applicable to receiving the offered services. The allotment of services may also identify the name of the service provider and a parameter describing the services offered by the service provider, but this information may be alternatively or additionally included in the service provider profile data that may be cross-referenced to, or associated with, the allotment of services. Embodiments may include any number of price discounts for the offered services and may include any number of time periods during which the price discounts are applicable. Still further, each service provider may provide an allotment of services for any number of identifiable offered services. For example, a service provider could provide one allotment of services for its catering services, another allotment of services for its dine-in services, and yet another allotment of services for its carry-out services.

The service provider may be in the business of delivering, performing or otherwise providing services of any type. Non-limiting examples of a service provider include a restaurant, a hotel, a vehicle rental business, an airline, a theater, and an amusement park. Furthermore, the service provider could be a residential remodeling contractor, an auto repair shop, a dry cleaner, hair salon, photography studio and the like. At any given time, each of these service providers has a certain amount of capacity to provide services. However, if some portion of this capacity goes unused for a period of time, the service provider has lost an opportunity to earn maximum income on that capacity.

An allotment of services describes a portion of the service provider's capacity to deliver, perform or otherwise provide services that the service provider is willing to offer at a discount in order to attract additional customers. However, some embodiments enable a service provider to divide up their capacity into time periods, such that the allotment of services may specify a limited time period during which a customer may obtain the specified discount. More specifically, the specified time period may be a time of day. For example, a restaurant may determine that they have substantial unused capacity between traditional meal times, such as between breakfast and lunch (perhaps from 9:00 to 11:00 am) and again between lunch and dinner (perhaps from 2:00 to 5:00 pm). While a dine-in restaurant may have a limited capacity of seating, all restaurants have a kitchen capacity that serves dine-in customers, take-out customers and delivery customers. So, a service provider may offer take-out or delivery services at a discount amount that is different than, and/or offered at a different time of day than, dine-in services. Furthermore, a hotel may offer room rental services for a particular night or day, but may also offer a room for any time period of the day (perhaps a morning period, an afternoon period, and/or an evening period). For example, a hotel located near a beach or a marathon finish line may offer a room for a fraction of a day so that a person or family may get out of the elements and take a shower before going to dinner or getting on a long plane ride home.

Each allotment of services may be uniquely identified or associated with the name of a particular service provider and a parameter describing the services offered by the service provider. The parameter describing the services offered may be any one or more of a wide range of parameters that describe the services. Some parameters may be generally applicable to all types of service providers, such as a parameter that identifies the location of the service provider. Other parameters may be unique to a particular type of service provider. For example, a parameter describing the services of a restaurant may be a certain cuisine or menu item and/or the availability of take-out or delivery services, a parameter describing the services of a hotel may be a room type or specific amenity, a parameter describing the services of a vehicle rental service may be an available vehicle type, a parameter describing the services of an airline may be a departure location and/or a destination, and a parameter of a theater may be a theater type (i.e., live musicals, live plays, movies and films, or special interest). It should be recognized that each service provider may be associated with multiple parameters describing their offered services.

The price discount in each allotment of services may be a discount rate (i.e., a percentage price reduction), a specific discount amount (i.e., a stated fixed amount of price reduction), or a particular discounted price (i.e., a stated fixed price) at which a particular service will be provided (i.e., a free menu item or $1.00 tacos). It should be further understood that the term “discount” may encompass various other types of promotional structures, such as “buy one get one free” or other incentives.

In order for the dynamic income optimization system computing device to receive an allotment of services from a plurality of service provider, each service provider may use a service provider computing device. The service provider computing device may be any computing device that can communicate over a wide area network with the dynamic income optimization system computing device, such as a desktop computer, laptop computer, tablet computer, automotive computer, smartphone, or wearable computing device. However, the service provider computing device may also be, include or communicate with, a point-of-sale computing system, which may actively track actual services rendered to customers, and identify unused capacity as a function of the time of day, day of the week or month, and/or holidays. Such point-of-sale computing system may interface with the dynamic income optimization system computing device over a wide area network, such as the Internet. Without limitation, such interface may be an application programming interface (API) or a graphical user interface of a web browser.

The operations may further comprise receiving, from a customer computing device, a query identifying a targeted/desired parameter describing a targeted/desired service, and transmitting, to the customer computing device, a graphical user interface for displaying the name of a service provider, from among the allotments of services received from the plurality of service provider computing devices, identified in one of the allotments of services in which the parameter describing offered services matches the targeted parameter of the targeted service. In order for the dynamic income optimization system computing device to receive the query, the customer may use a customer computing device. The customer computing device may be any computing device that can communicate over a wide area network with the dynamic income optimization system, but non-limiting examples of the customer computing device include a desktop computer, laptop computer, tablet computer, automotive computer, smartphone, or wearable computing device. The dynamic income optimization system computing device may transmit the graphical user interface to the same customer computing device that sent the query. Optionally, the graphical user interface may display the names of a plurality of service providers, from among the allotments of services received from the plurality of service provider computing devices, identified in the allotments of services in which a parameter describing offered services matches the targeted parameter of the service targeted in the query.

Still further, the operations may comprise receiving various types of input from the customer computing device. In some embodiments, the operations may still further comprise receiving input from the customer computing device identifying, from among the service providers displayed in the graphical user interface, a selected service provider. However, the input received from the customer computing device may or may not further include making a reservation with the selected service provider and may or may not further include initiating a prepayment of a prepaid purchase amount. These two factors (i.e., whether or not a reservation is made, and whether or not a prepayment is made) have four possible combinations: (1) the input received makes a reservation and a prepayment, (2) the input received makes a prepayment, but no reservation, (3) the input received makes a reservation and no prepayment, and (4) the input makes no reservation and no prepayment. Each of these four possible combination are discussed below. In some embodiments that make a reservation, the operations may further comprise receiving input from the customer computing device identifying a selected time for the reservation, and perhaps also identifying a number of people, tables or other units of services that are being reserved. When a reservation is not being made, the customer may request services at any available time and simply have to wait for first available services. In some embodiments that make a prepayment, the input may further comprising initiating payment of an amount of prepaid services, such as by initiating a credit card payment, debit card payment, or other form of payment. When a prepayment is not being made, the customer may make payment at the time of receiving the services (i.e., when a bill is presented to the customer immediately before or immediately after rendering services to the customer). While the payment at the time of receiving the services may be made with a credit card payment, debit card payment, or other form of payment, some embodiments may further comprise the use of a prepaid customer account or wallet that is managed or authorized by the dynamic income optimization system. Optionally, one or more of the price discounts in the allotments of services may be honored only if the customer makes payment using a prepaid customer account or wallet managed or authorized by the dynamic income optimization system. The use of the prepaid customer account or wallet may reduce collection risk and/or avoid third party credit card fees for each transaction.

In some embodiments, the operations may allow the customer to open a prepaid account or wallet and may load (i.e., fund, credit or recharge) that prepaid account with any amount of money, such as through the transfer of funds from a bank account or a charge to a debit card, credit card or other payment form. After a customer has established such a prepaid account having a positive balance, the customer may avoid making a prepayment for the total prepaid purchase amount of the selected services. Optionally, the customer's account may exhibit a “hold” for the total purchase amount pending the customer actually receiving the selected services. When the customer receives the services from a service provider, whether they had a reservation or not, the customer may pay the total bill using the prepaid account. Optionally, a payment on account may be authorized using a special QR code displayed on the customer's mobile computing device. If the customer does not have a sufficient balance in their account to cover the total bill, then the customer may load or transfer more money into their account to complete the payment. The dynamic income optimization system may adjust the payment amount to reflect the discount applicable for the services at the time of payment and then reduce the remaining balance in the customer's account in the amount of the new payment.

In some embodiments, the operations may comprise receiving input from the customer computing device identifying, from among the service providers displayed in the graphical user interface, a selected service provider and a selected time or time period during which a selected price discount is applicable to the provision of the offered services. The selection of a specific time may be considered to be an act of making a reservation. The input from the customer computing device may further identify the customer and a total prepaid purchase amount of the selected offered services to be prepaid by the customer. The operations may also comprise receiving a prepayment initiated from the customer computing device for the total prepaid purchase amount of the selected offered service less the selected price discount that is applicable to the provision of the selected offered services at the selected time or during a selected time period. Optionally, the prepayment to be initiated from the customer computing device may be for the total prepaid purchase amount of the selected offered service, plus a commission, less the selected price discount that is applicable to the provision of the selected offered services at the selected time or during the selected time period.

The operations may additionally comprise storing a voucher that identifies the customer, the selected service provider, the selected time or time period during which the selected price discount is applicable to the rendering of the selected offered services, and the total prepaid purchase amount of the selected offered services for which prepayment has been received or credited to the customer account or wallet on the dynamic income optimization system, and transmitting a voucher notification to the service provider computing device of the selected service provider, wherein the voucher notification identifies the customer and the selected time or time period during which the selected price discount is applicable to the rendering of the selected offered services.

The term “voucher”, as used herein, means a record indicating a credit against a future purchase or expenditure. The term “voucher” encompasses a ticket, certificate, and/or coupon. Furthermore, a voucher may be a physical document, an electronic record, and/or other storage media, and may be referenced or obtain through uses of a one dimensional barcode, a two dimensional barcode or matrix code such as a Quick Response (QR) code, and/or other optical or electromagnetic patterns or signals.

In some embodiments, the operations may also comprise receiving an invoice from the service provider computing device of the selected service provider after the service provider has rendered services to the customer, wherein the invoice identifies the service provider that rendered services to the customer, the customer that received the services and a time at which the customer received the services. Optionally, the invoice may further include an actual purchase amount of the offered services and the amount of discount applied. In some embodiments, the operations may further comprise determining whether the service provider, the customer, and the time identified in the invoice match the service provider, the customer, and the time identified in a stored voucher. The operations may then further comprise initiating payment to the service provider in response to receiving the invoice and reaching a positive determination that the service provider, the customer, and the time identified in the invoice match the service provider, the customer, and the time identified in the stored voucher. In the case of a prepaid voucher, the dynamic income optimization system has already received prepayment from the customer, and initiates payment to the service provider upon confirmation that the services were actually provided. This confirmation may be satisfied through the content of the invoice, such as the customer identity, voucher or reservation numbers that the service provider obtained from the customer, the customer's account number and/or other confirming information.

In some embodiments, the operations may further comprise providing a service provider interface that is accessible over a wide area network, wherein the service provider interface is accessible to the service provider computing device in response to authentication of the service provider, and wherein the allotment of service is received from the service provider computing device through the service provider interface. Optionally, the service provider interface may provide a graphical user interface and other features to support all interactions between the service provider and the dynamic income optimization system. For example, in addition to receiving an allotment of services, the same service provider interface may support receiving of invoices from the service provider computer. The graphical user interface is preferably transmitted from the dynamic income optimization system to the service provider computing device for displaying an allotment entry screen, an invoicing screen, and a payment reconciliation screen. Other information, features and customer service options may also be accessed via the graphical user interface. The service provider interface may take many forms, such as a website that can be viewed and interacted with using a web browser.

In some embodiments, the operations may further comprise providing a customer interface that is accessible over a wide area network, wherein the customer interface is accessible to the customer computing device in response to authentication of the customer, and wherein the input is received from the customer computing device through the customer interface. Optionally, the customer interface may provide a graphical user interface and other features to support all interactions between the customer and the dynamic income optimization system. For example, the customer interface may support the dynamic income optimization system receiving a query from the customer computing device, and receiving input from the customer computing device identifying a selected service provider from among any number of service providers. In some embodiments, the customer interface may support the dynamic income optimization system receiving a selected time or time period and/or a selected total prepaid purchase amount. Furthermore, the customer interface may be used by the customer computing device to initiate a prepayment and/or load credit into a prepaid customer account or wallet. The graphical user interface is preferably transmitted from the dynamic income optimization system to the customer computing device. In some embodiments, the graphical user interface may display a service query screen, a voucher purchase screen, a voucher screen, and/or a screen for loading or crediting a prepaid customer account or wallet. Other information, features and customer service options may also be accessed via the graphical user interface. In one additional option, the graphical user interface may provide a plurality of predetermined prepaid purchase amounts, where the customer may then select a total prepaid purchase amount of the selected offered services to be prepaid by the customer from a plurality of predetermined prepaid purchase amounts.

In some embodiments, the operation of receiving, from each of a plurality of service provider computing devices, an allotment of services available at a discount from the service provider, may include periodically receiving, from each of the plurality of service provider computing devices, an updated allotment of services available at a discount from the service provider. In other words, the service provider computing device may dynamically update any allotment of services that is associated with the service provider. Specifically, the service provider computing device may dynamically change the discount rate or the time period during which the discount rate is applicable to services to be received by a customer. In one practical application, should the service provider point-of-sale computer indicate that a large reservation was just received from a source outside the present dynamic income optimization system or that the wait staff will be smaller than planned, the service provider and/or service provider point-of-sale computer could communicate with the dynamic income optimization system, either automatically or in response to a user command, to reduce or eliminate the discount rate or narrow, eliminate or shift the time period during which the discount rate is applicable to services to be received by a customer, and/or reduce the number of units of service available in an existing allotment of services. Such dynamic modification of an allotment of services may be immediately reflected in the graphical user interfaces subsequently transmitted to customer computing devices.

In some embodiments, the allotment of services received from one or more of the service provider computing devices may identify multiple price discounts for the offered services, wherein each of the multiple price discounts is identified with a unique time period during which the price discount is applicable to a purchase of the offered services. Furthermore, the allotment of services may identify multiple offered services, wherein each of the offered services is associated one or more price discounts identified with one more time period during which the price discount is applicable to a purchase of each of the offered services. Still further, the dynamic income optimization system may receive one or more allotments of services from each service provider computing device, such as a separate allotment of services for each day of the week or some other schedule.

In some embodiments, the query from the customer computing device may further identify a selected geographical area, wherein the graphical user interface does not display the name of a given service provider that may otherwise satisfy the query in response to the given service provider having a location that is not within the selected geographical area. In some similar embodiments, the query from the customer computing device may further identify a designated location and a maximum distance, and wherein the graphical user interface does not display the name of a service provider in the query results in response to the service provider having a location that is further from the designated location than the designated maximum distance.

In some embodiments, the graphical user interface provided to the customer computing device may display a map, wherein the map displays, for each of the offered services that satisfy the one or more parameter of the targeted service, an icon positioned on the map to indicate the location of the service provider identified in the allotment of services in association with the offered services. In other words, after the dynamic income optimization system receives a query, the dynamic income optimization system may generate query results in the form of a graphical user interface displaying a map with the locations of one or more service providers that satisfy the one or more parameter of the services targeted in the customer's query. A service provider may be considered to “satisfy” a query in response to the dynamic income optimization system having profile information for the service provider or an allotment of services received from the service provider that include parameters that match the parameters of the customer's query. For some parameters, a service provider may only “satisfy” the query if the parameters associated with the service provider are an exact match with the parameters in the query. In one example, a service provider having a profile indicating that they serve “Italian” cuisine will only satisfy a customer query searching for “Italian” cuisine. Such an exact match may be facilitated by the service provider interface having a drop down list of predetermined cuisines from which to establish their profile and the customer interface having an identical drop down list of predetermined cuisines from which to form the customer query. For some parameters, a service provider may be considered to “satisfy” the query if the parameters associated with the service provider merely meet the criteria or parameters in the query. In one example, a service provider having a particular location that is one mile from the customer's current location will meet a query criteria or parameter that requests a service provider within two miles from the customer's current location.

In some embodiments, each of the offered services that satisfy the one or more parameter of the service targeted in a query may be displayed to the customer in a graphical user interface including an icon that represents the service provider, wherein the icon includes one or more visual indicator of the price discount identified in an allotment of services in association with the offered services. A specific example of the one or more visual indicator of the price discount includes one or more colored borders around the icon, where each color is associated with, or represents, a given price discount. Modifying the icon to include a colored border that identifies one or more price discounts that are available from the service provider allow a customer to quickly compare service provider discounts and make a service provider selection. Optionally, a colored element of the icon may represent the highest price discount that is available from the service provider. In a further option, the one or more visual indicator of the price discount may include an icon or border about an icon that is made to blink in response to the available quantity of units being less that a predetermined threshold quantity of units. Furthermore, the icon may be a map location icon.

In some embodiments, the allotment of services may further include a total quantity of units of the offered services qualifying for the price discount. The quantity of units included in the allotment of services may be any quantity up to a total capacity of the service provider. In an example where the service provider is a restaurant, the units of the offered services may be designated as a number of seats, tables and/or rooms. Furthermore, input from the customer computing device may identify a requested quantity of units of the offered services, such that the dynamic income optimization system may refuse a customer's attempted reservation of services from a selected service provider if the customer has selected a greater quantity of units than are available in an allotment. After any customer has made a reservation with a selected service provider for a selected time or time period, the reservation record stored by the dynamic income optimization system may identify a reserved quantity of units of the offered services. In some embodiments, the operations may comprise tracking an available quantity of units by subtracting any reserved quantity of units from the total quantity of units set out in an allotment, and rejecting a reservation request from a customer computing device in response to the reservation request identifying a number of units exceeding the available quantity of units.

In some embodiments, the operations may further comprise the dynamic income optimization system transmitting a prepayment code to the customer computing device in response to receiving prepayment from the customer. In one option, the customer may later, at the time of receiving service, provide the prepayment code to the service provider at checkout, such that the prepayment code may be used in the service provider's invoice submitted to the dynamic income optimization system. In this option, only the customer provides the prepayment code to the service provider, such that submission of the prepayment code to the dynamic income optimization system in an invoice may be used as proof that the customer received the services. Accordingly, payment from the dynamic income optimization system to the service provider for the prepaid services may be contingent upon the received invoice including the prepayment code. The payment initiated to the service provider may be an amount that is based on the total prepaid purchase amount.

In some embodiments, at the time of making a prepayment, the dynamic income optimization system may transmit a prepayment code to the customer computing device along with other details about the prepayment transaction in the form of a customer voucher or transaction summary. Optionally, the operations may further comprise the dynamic income optimization system transmitting a transaction summary to the customer computing device in response to receiving prepayment from the customer. The transaction summary may include the prepayment code, the identity of the selected service provider, the selected time or time period during which the selected price discount is applicable to the rendering of the selected offered services, and the total prepaid purchase amount of the selected offered services for which prepayment has been received. Further information may be included in the transaction summary for the convenience of the customer, such as the address and telephone number of the selected service provider or an amount of the selected price discount that is applicable to the rendering of the selected offered services.

Some embodiments may allow for a customer to cancel a reservation or a reservation involving a voucher. In one such embodiment, the operations may further comprise the dynamic income optimization system receiving input from the customer computing device requesting cancellation of a specific stored voucher that identifies the customer, canceling the specific stored voucher and providing credit to the customer in an amount of the prepayment less a cancellation fee, and transmitting a cancellation message to the service provider computing device of the selected service provider, wherein the cancellation message identifies the customer and the selected time period of the selected offered services that are being canceled. Optionally, if input is received from the customer electing to receive credit toward another voucher rather than a return of funds, then the dynamic income optimization system may waive the cancellation fee.

In some embodiments, a funded prepaid account or wallet for a given customer may be used as an alternative to prepayment for selected services. For example, rather than making a prepayment that is specific to selected services from a selected service provider, a customer may elect to apply their funded prepaid account or wallet to any and/or all selected services from one or more service providers. Whereas making a prepayment may result in sending a prepayment code to the customer, using a prepaid account or wallet for selected service may not involve any money changing hands at the time that the services are selected such that a prepayment code may not be sent. Rather, in the case of a customer using their prepaid account or wallet, the customer should use their prepaid account or wallet to pay the service provider at the time of receiving the services. A potential benefit of using a prepaid account or wallet, rather than a prepayment, is that it may eliminate the need to predetermine an amount or estimated amount to be paid for the services. The prepaid account or wallet must simply have a sufficient credit balance to pay for services at the time the services are rendered. In one example, a customer may make multiple reservations yet their prepaid account or wallet need only have a sufficient balance to cover services received at the point in time of each reservation.

In some embodiments, when a customer pays a service provider for rendered services using their prepaid account or wallet, the service provider computing device may interface with the dynamic income optimization system to submit the customer account number or other identifier and request verification that the customer's prepaid account or wallet has a sufficient balance to pay for the total amount of the services. Accordingly, the operations may further comprise receiving a prepaid account balance inquiry and a requested payment amount, and sending a balance verification message to the service provider. If the customer's prepaid account balance is insufficient to cover the cost of the services, the customer may use the customer computing device to interface with the dynamic income optimization system to load additional funds into their prepaid account or wallet.

Some embodiments may be directed to a system or apparatus comprising at least one non-volatile storage device storing program instructions and at least one processor configured to process the program instructions, wherein the program instructions are configured to, when processed by the at least one processor, cause the apparatus to perform various operations. The program instructions may include any of the program instructions disclosed herein in the context of a computer program product, and the various operations may include any of the operations performed by the processor in the any of embodiments discloses herein.

Some embodiments provide a computer program product comprising a non-volatile computer readable medium and non-transitory program instructions embodied therein, the program instructions being configured to be executable by a processor to cause the processor to perform various operations, such as helping a service provider to develop an appropriate allotment of services over a plurality of time periods in order to increase their income. The operations may comprise identifying a total number of units of service available from a service provider for sale at a discount, and setting a plurality of time periods over which the identified number of units of service are available, wherein the plurality of time periods includes a first time period. The operations may further comprise establishing, for each of the time periods, an initial distribution of the total number of units among three discount levels, wherein the initial distribution includes a first number of units available at a first discount, a second number of units available at a second discount, and a third number of units available at a third discount, wherein the first discount is greater than the second discount, and wherein the second discount is greater than the third discount. During a plurality of instances of the first time period, the operations may comprise tracking a number of units of service that are sold at each discount level during the latest instance of the first time period, calculating an amount of income received from the sale of units of services during the latest instance of the first time period, and, for an immediately subsequent instance of the time period:
reducing the number of units available at the first discount by a predetermined percentage and increasing the number of units available at the second discount to include the number of units that are no longer available at the first discount in response to (1) the amount of income during the latest instance of the first time period being greater than the amount income during the previous instance of the first time period, (2) the units available at the first discount and the second discount being sold out during the time period, and (3) the number of units available at the first discount being greater than a predetermined minimum number of units;
reducing the number of units available at the second discount by the predetermined percentage and increasing the number of units available at the third discount to include the number of units that are no longer available at the second discount in response to (1) the amount of income during the latest instance of the first time period being greater than the amount income during the immediately prior instance of the first time period, (2) the units available at the first discount and the second discount being sold out during more than a preset number of instances of the time period and (3) the number of units available at the third discount being less than a predetermined maximum number of units; and
making no change in the number of units available at the first discount, the number of units available at the second discount, and the number of units available at the third discount for an immediately subsequent instance of the time period in response to (1) the amount of income during the latest instance of the first time period being greater than the amount income during the previous instance of the first time period, and (2) the units available at the first discount and the second discount not being sold out during the latest instance of the time period.

In some embodiments, the operations may, during the plurality of instances of the first time period, further comprise, for an immediately subsequent instance of the time period, returning the number of units available at the first discount, the number of units available at the second discount, and the number of units available at the third discount to the amounts available in an immediately prior instance of the time period in response to the amount of income during the latest instance of the first time period being less than the amount of income during the immediately prior instance of the time period.

In some embodiments, the operations may, during the plurality of instances of the first time period, further comprise, for an immediately subsequent instance of the time period, making no change in the number of units available at the first discount, the number of units available at the second discount, and the number of units available at the third discount for a subsequent time period in response to the amount of income during the latest instance of the first time period being equal to the amount of income during the immediately prior instance of the time period. In one option, each of the time periods may be a range of time during a period of a day, and each instance of the first time period may be a range of time during a given day.

In some embodiments, the plurality of time periods may include a second time period. Accordingly, during a plurality of instances of the second time period, the operations may further comprising tracking a number of units of service that are sold at each discount level during the latest instance of the second time period, calculating an amount of income received from the sale of units of services during the latest instance of the second time period, and, for an immediately subsequent instance of the time period:
reducing the number of units available at the first discount by a predetermined percentage and increasing the number of units available at the second discount to include the number of units that are no longer available at the first discount in response to (1) the amount of income during the latest instance of the second time period being greater than the amount income during the previous instance of the second time period, (2) the units available at the first discount and the second discount being sold out during the time period, and (3) the number of units available at the first discount being greater than a predetermined minimum number of units;
reducing the number of units available at the second discount by the predetermined percentage and increasing the number of units available at the third discount to include the number of units that are no longer available at the second discount in response to (1) the amount of income during the latest instance of the second time period being greater than the amount income during the immediately prior instance of the second time period, (2) the units available at the first discount and the second discount being sold out during more than a preset number of instances of the time period and (3) the number of units available at the third discount being less than a predetermined maximum number of units; and
making no change in the number of units available at the first discount, the number of units available at the second discount, and the number of units available at the third discount for an immediately subsequent instance of the time period in response to (1) the amount of income during the latest instance of the second time period being greater than the amount income during the previous instance of the second time period, and (2) the units available at the first discount and the second discount not being sold out during the latest instance of the time period.

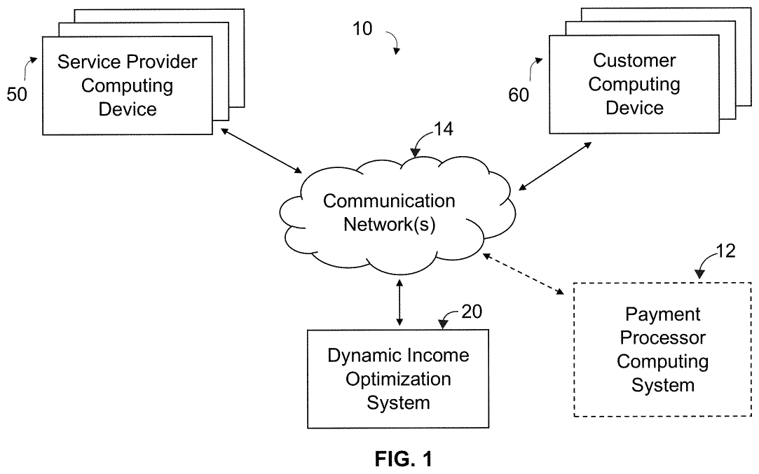

FIG. 1 is a diagram of a system 10 including a dynamic income optimization system 20, a plurality of service provider computing devices 50, a plurality of customer computing devices 60, and a payment processor computing system 12. Each of the entities 20, 50, 60, 12 are capable of communicating over one or more communication network 14. The communication network may include a wide area network (WAN) such as the Internet, one or more local area networks (LAN), and/or a cellular or mobile network. The entities 20, 50, 60, 12 may communicate over the communication network 14 using a communication standard that is appropriate to the type of network. For example, any portion of the communication network that includes the Internet may use the communication standard known as the Internet protocol suite, which may also be referred to as TCP/IP (Transmission Control Protocol/Internet Protocol). Furthermore, any portion of the communication network that includes a local area network may use the communication standard known as Ethernet and/or WiFi. Other communication standards may also be used.

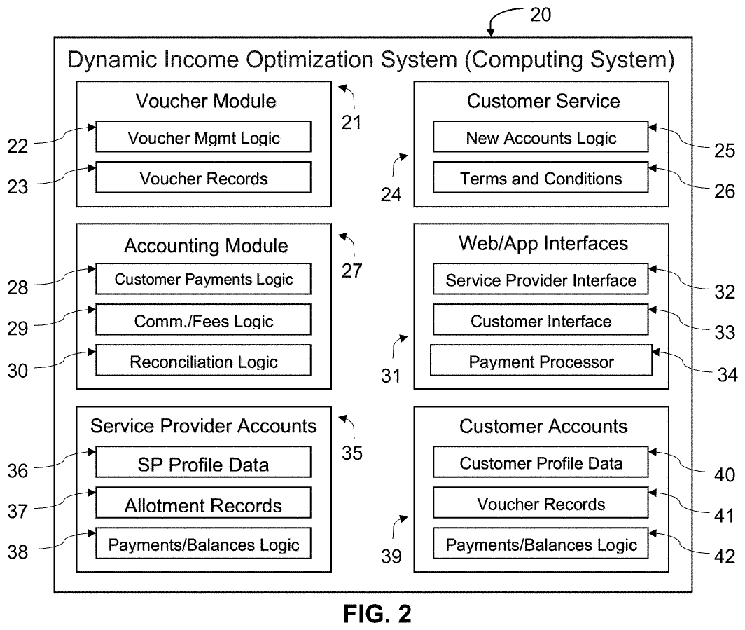

FIG. 2 is a block diagram of program instruction modules that may be used by the dynamic income optimization system 20. In this non-limiting example, the dynamic income optimization system 20 executes program instructions divided into six modules: a voucher module 21, customer service module 24, accounting module 27, web/app interfaces module 31, service provider accounts module 35 and customer accounts module 39.

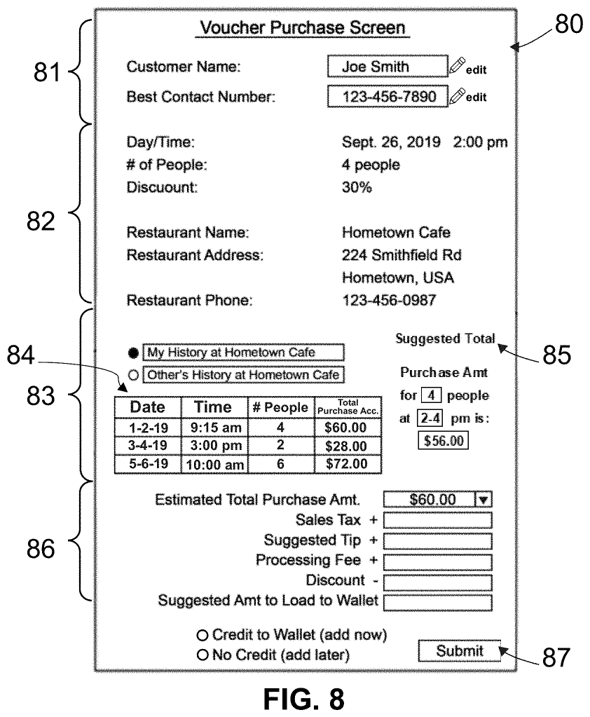

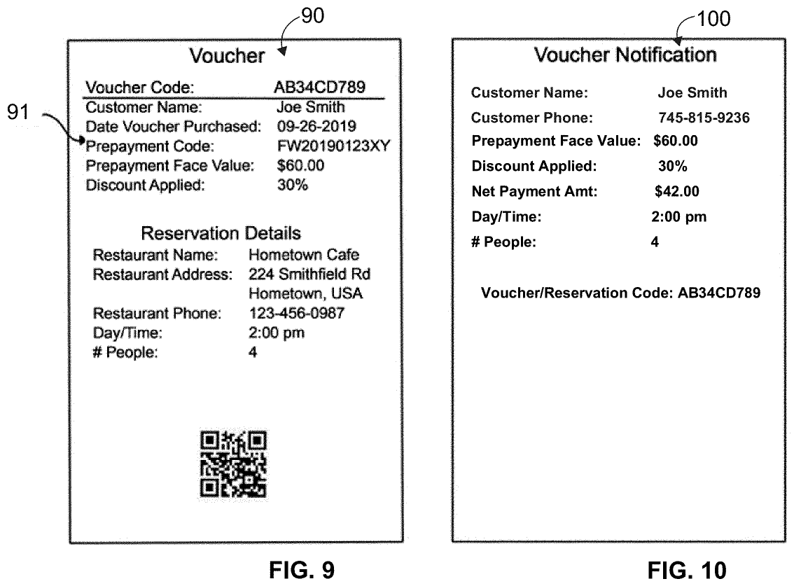

The voucher module 21 may include voucher management logic 22 for managing how the parameters in a customer's query are matched up with offered services in one or more of the allotment of services and how a customer selects an offered service and completes a prepaid voucher. The voucher module 21 also includes voucher records 23 that document all of the outstanding (unredeemed) vouchers. Furthermore, the voucher records may optionally include a history of redeemed vouchers. The voucher records may include, without limitation, a plurality of voucher records, where each voucher record may include any or all of the information shown in the voucher purchase screen 80 of FIG. 8, the voucher 90 of FIG. 9, the voucher notification 100 of FIG. 10, customer profile data 40 of FIG. 2 for the customer, and service provider profile data 36 of FIG. 2. In embodiments that allow customers to use a prepaid account or wallet, the voucher management logic may be replaced with or supplemented with reservation management logic to track reservations and/or other purchases of services even if a voucher is not issued. Similarly, the voucher records 23 may include or be replaced with reservation or transaction records in embodiments that allow customer to user a prepaid account or wallet.

The customer service module 24 includes new account logic 25 for establishing new customer accounts and includes terms and conditions logic 26 for ensuring that a customer is made aware of the procedures for submitting a query, redeeming a prepaid voucher, etc. and any cancellation policy and/or other legal terms.

The accounting module 27 includes customer payments logic 28 for managing customer prepayments and refunds, managing customer prepaid accounts or wallets as well as for interfacing with a payment processor computing system. The accounting module 27 also includes commissions/fees logic 29 for calculating, charging and collecting commissions and fees for the operators of the dynamic income optimization system, and includes reconciliation logic 30 for receiving service provider invoices, comparing those invoices against the voucher records, and initiating payment for validated entries in the invoices.

The web/app interfaces module 31 includes service provider interface logic 32 for generating and transmitting a graphical user interface to each of the service provider computing devices, and for receiving input from the service provider computing device. The web/app interfaces module 31 also includes customer interface logic 33 for generating and transmitting a graphical user interface to each of the customer computing devices, and for receiving input (including queries, prepayments, prepaid account funding, etc.) from the customer computing device. Still further, the web/app interfaces module 31 includes payment processor interface logic 34 for initiating and handling payment transactions with a payment processor computing system, including logic for receiving customer prepayments, receiving funds for customer prepaid accounts or wallets, and for sending payments on invoices to the service providers.

The service provider accounts module 35 includes SP (service provider) profile data 36, such as each service provider's name, address, phone number, username, password and parameters of the services offered, such as a parameter describing the services offered by the service provider. Each service provider's profile data may be changed from time to time, but may not require change as a result of the embodiments disclosed. The service provider accounts module 35 also includes allotment records 37 that store all of the allotments of services received from the plurality of service providers. Each allotment record or allotment of services is uniquely identified with a particular service provider and may identify a price discount for the offered services, and a time period during which the price discount is applicable to receiving the offered services. Each allotment record may further identify a total quantity of units of the offered services qualifying for the price discount. Optionally, an allotment of services received from one or more of the service provider computing devices may identify multiple price discounts for the offered services, where each price discount is associated with a unique time period during which the price discount is applicable to a purchase of the offered services. While certain examples disclosed herein are directed to three price discount levels, embodiments may include any number of one or more price discount levels without limitation. In a non-limiting example, the allotments records 37 may be stored in a data structure that may be conceptualized as a table with a plurality of records (one record per row), where each record stores one allotment of services. In this manner, each allotment of services record may include a price discount field and a time period field, wherein the price discount and the time period are associated by virtue of being stored in fields of the same record. Other data structures may be used and may have their own manner of identifying an association between a price discount and a time period, and perhaps other data fields such as the quantity of units of service. Still further, the service provider accounts module 35 includes payments/balance logic 38 for initiating payments to the service providers and for maintaining an account balance relative to each service provider. Optionally, the payments/balance logic 38 may handle other transactions relative to each service provider, including a possible fee for determining appropriate allotments of services to maximum the service provider's income over time.

The customer accounts module 39 includes customer profile data 40 for each customer, such as the customer name, phone number, username, password and stored credit card information. The customer accounts module 39 may also include voucher records 41 that store current (unredeemed) vouchers for which the customer has prepaid, and perhaps also store a history of past vouchers redeemed by the customer. Still further, the customer accounts module 39 may include payments/balances logic 42 for receiving and/or recording payments initiated by the customer, and for maintaining an account balance relative to each customer. The customer accounts module may be used for voucher prepayments and/or prepaid account or wallet transactions. Optionally, the payments/balance logic 42 may handle other transactions relative to each customer.

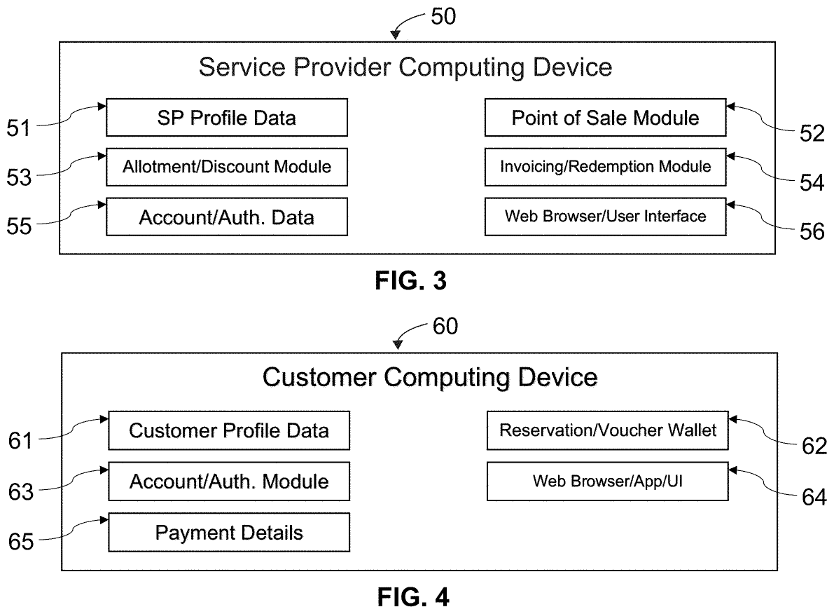

FIG. 3 is a block diagram of program instruction modules that may be used by the service provider computing device 50. In this non-limiting example, the service provider computing device 50 executes program instructions divided into six modules: SP (service provider) profile data 51, point-of-sale module 52, allotment/discount module 53, invoicing/redemption module 54, account/authentication data 55 and web browser/user interface 56. The SP (service provider) profile data 51 includes a variety of information about the service provider that may be provided to the dynamic income optimization system 20 for storage as the service provider profile data 36 of FIG. 2. The point-of-sale module 52 may include logic for interfacing with a service provider's point-of-sale system. For example, the point-of-sale module 52 may obtain capacity utilization data that may be used by the allotment/discount module 53 to determine and submit an allotment of services to the dynamic income optimization system 20. The point-of-sale module 52 may also receive and collect prepayment codes from customers that have redeemed their vouchers, and provide the prepayment codes to the invoicing/redemption module 54 for preparing and sending an invoice to the dynamic income optimization system 20. Similarly, the point-of-sale module 52 may also receive and collect prepaid account identifier from customers that have used a prepaid account to pay for services, and provide the prepaid account identifier to the invoicing/redemption module 54 for preparing and sending an invoice to the dynamic income optimization system 20. Still further, the point-of-sale module 52 may use the account/authentication data 55 and the web browser/user interface 56 to access the dynamic income optimization system 20 for verifying that a customer prepayment code is valid and verify the face value of the prepayment or verifying that a customer prepaid account balance is sufficient to cover the cost of rendered services. The face value of the prepayments may be subtracted from the customer's bill for services received at the service provider. The account/authentication data 55 may store the service provider's account information and authentication information to be used by the service provider computing device 50 along with the web browser/user interface 56 at any time the service provider needs to interact with the dynamic income optimization system 20, such as when submitting profile data and when provide or updating an allotment of services.

FIG. 4 is a block diagram of program instruction modules that may be used by the customer computing device 60. In this non-limiting example, the customer computing device 60 executes program instructions divided into five modules: customer profile data 61, reservation/voucher wallet 62, account/authentication module 63, web browser/app/user interface 64, and payment details 65.

The customer profile data 61 includes a variety of information about the customer that may be provided to the dynamic income optimization system 20 for storage as the customer profile data 40 of FIG. 2. The reservation/voucher wallet module 62 may store records of the customer's unredeemed reservations/vouchers, and perhaps a history of previously redeemed reservations/vouchers. The account/authentication module 63 may store the customer's account information and authentication information to be used along with the web browser/app/user interface module 64 to access the dynamic income optimization system 20. For example, the dynamic income optimization system may be accessed when the customer is submitting a query, selecting a prepaid voucher for offered services, requesting a cancellation, simply checking on their account activity and/or other activities described herein. The payment details module 65 may include the customer's stored modes of payment, such as credit card information, debit card information, PayPal account information or other forms of payment.

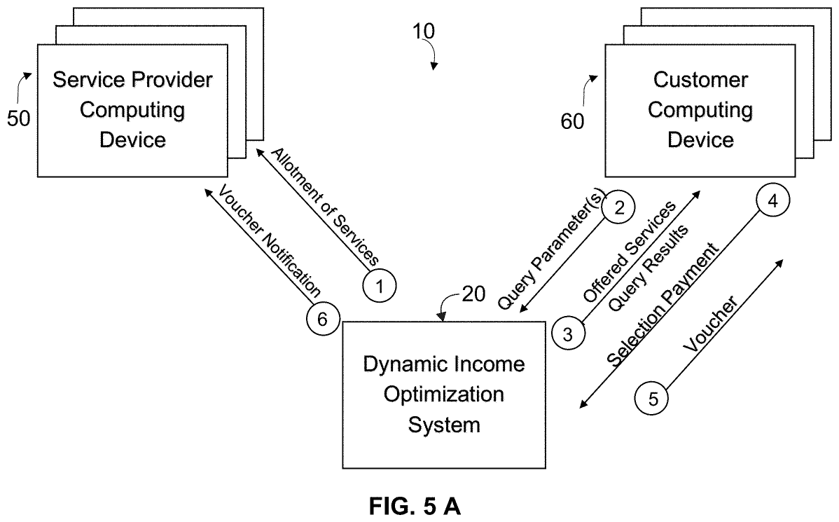

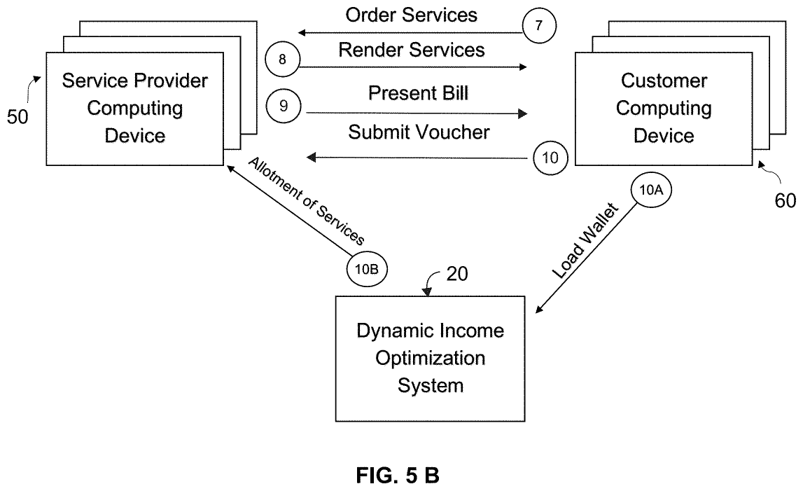

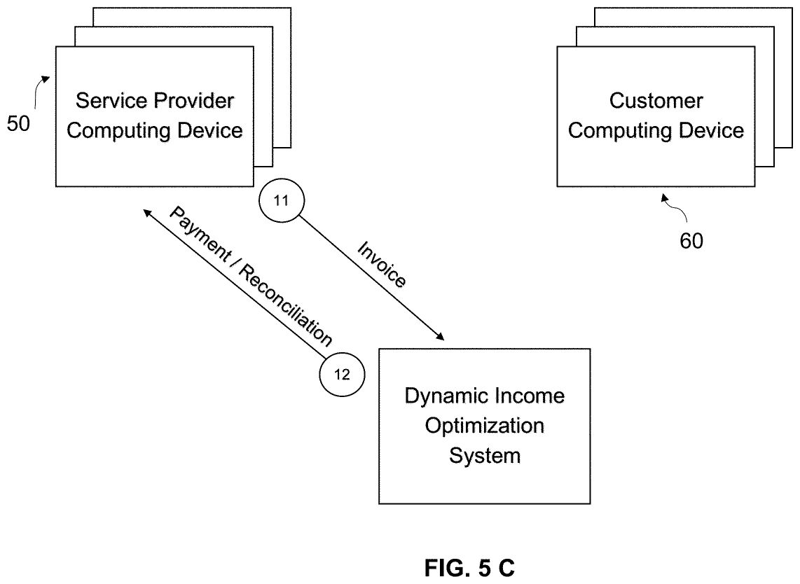

FIGS. 5A-C are process flow diagrams that illustrate the data flows and interactions among the dynamic income optimization system 20, the plurality of service provider computing devices 50, and the plurality of customer computing devices 60 as shown in FIG. 1. For simplicity, the payment processor computing system 12 and the communication network(s) 14 are not shown. However, it should be understood that the communication network(s) 14 are involved in any communication between the dynamic income optimization system 20 and either the plurality of service provider computing devices 50 or the plurality of customer computing devices 60. It should also be understood that the payment processor computing system 12 may be involved in any operation that involves a payment. The operations according to one embodiment are shown at a high level, with each operation associated with a number inside a circle attached to an arrow. The number in the circle indicates an operation number according to this embodiment and the operation is indicated by the words written along the length of the arrow. Certain human interactions between a customer and a service provider may be identified for completeness, but such interactions are not operations of the dynamic income optimization system.

FIG. 5A is a process flow diagram illustrating a first set of operations of the dynamic income optimization system 20. In operation 1, the dynamic income optimization system 20 receives an allotment of services from a service provider computing device 50. In fact, the dynamic income optimization system 20 will preferably receive an allotment of services from each of a plurality of service provider computing devices 50. In one example, each allotment of services may identify, or be associated with, the name of the service provider that is offering the allotment of services and a parameter describing the services being offered. Each allotment may include one or more price discount for the offered services and, for each price discount, a time period during which the price discount is applicable to a customer receiving the offered services.

In addition, the first time that a service provider submits an allotment of services, the service provider computing device 50 should also send the service provider profile data that includes various parameters describing the services offered by the service provider. Such parameters may include, without limitation, the service provider's name, address and phone number, as well as parameters describing the offered services. In an example in which the service provider is a restaurant, parameters describing the offered service may include an identification of the cuisine served, perhaps further identifying popular food items, beverages, and other relevant features.

In operation 2, the dynamic income optimization system 20 receives one or more query parameters from a customer computing device 60. The one or more query parameters identify a targeted service that the customer would like to receive. For example, a customer query may include a restaurant cuisine parameter and a geographical area parameter. Any type and number of parameters may be included in the customer query. However, in various embodiments, the type and value of the parameters available for inclusion in a customer query may be limited to query parameters that are predetermined or limited by the dynamic income optimization system. Such predetermined query parameters may be selected through the customer graphical user interface. Furthermore, the predetermined query parameters available in the customer graphical user interface should correspond with parameters submitted by the service providers to describe their offered services. For this purpose, the service provider graphical user interface may also include predetermined parameters from which the service provider may select the parameter values that best describe their offered services.

In operation 3, the dynamic income optimization system 20 provides a graphical user interface to the customer computing device 60 for displaying the name of one or more service providers that are associated with profile data and/or an allotment of services that satisfy the query parameters. For example, the dynamic income optimization system 20 may search through all of the allotments of services received from the plurality of service provider computing devices to identify which of the allotments of services include, or are associated with, the parameters in the customer query. If the customer query includes target parameters for an amount of discount and/or a time for receiving services, then the dynamic income optimization system 20 may search through all of the allotments of services. If the customer query includes target parameters for a cuisine or geographical location, then the dynamic income optimization system 20 may search through the service provider profile data associated with one or more allotment of services. Depending upon the one or more parameters in a customer query, the dynamic income optimization system may search both the allotments of services and the service provider profile data identify a service provider that satisfies all of the parameters in a given customer query.

In operation 4, the dynamic income optimization system 20 may receive input from the customer computing device 60 identifying, from among the service providers identified in the query results displayed in the graphical user interface, a selected service provider and a selected time or time period during which a selected price discount is applicable to the provision of the offered services. The input received from the customer computing device 60 may further identify the customer, perhaps by name or customer identification code, and either a total prepaid purchase amount of the selected offered services to be prepaid by the customer or an indication that the customer wants to pay with the customer's prepaid account or wallet. The dynamic income optimization system 20 may also receive a prepayment, or at least notification of a prepayment, initiated by the customer computing device 60 for the total prepaid purchase amount of the selected offered service less the selected price discount that is applicable to the provision of the selected offered services during the selected time period. While the customer computing device 60 initiates the prepayment, the prepayment or notification of prepayment may be received from a payment processor computing system 12 and credited to the customer's account. Similarly, if a customer computing device initiates loading additional funds into a prepaid account or wallet, the funding or notification of funding may be received from a payment processor computing system 12 and credited to the customer's prepaid account. However, in embodiments that allow a customer to establish and use a prepaid account, a payment may not be received in operation 4 if the customer's prepaid account already has a sufficient balance or if the customer will fund a sufficient balance prior to receiving the services.

In operation 5, the dynamic income optimization system 20 stores a voucher that identifies the customer, the selected service provider, the selected time period during which the selected price discount is applicable to the rendering of the selected offered services, and the total prepaid purchase amount of the selected offered services for which prepayment has been received. As shown, the dynamic income optimization system 20 may transmit a copy of the voucher to the customer computing device 60. Furthermore, the dynamic income optimization system 20 may generate a unique voucher code and a unique prepayment code, store the voucher code and prepayment code in association with the voucher, and provide the voucher code and prepayment code in the voucher transmitted to the customer computing device 60. The customer may subsequently provide the voucher code and/or prepayment code to the selected service provider at the time that service is rendered. In embodiments that allow a customer to pay with a prepaid account or wallet, the voucher may be replaced with a simple reservation since a prepayment specific to this purchase is not being made. The reservation may be stored and transmitted to the customer computing device in the same manner as a voucher, but may include a reservation code rather than a voucher code and prepayment code.

In operation 6, the dynamic income optimization system 20 transmits a voucher notification to the service provider computing device 50 of the selected service provider, wherein the voucher notification identifies the customer name and the selected time or time period during which the selected price discount is applicable to the rendering of the selected offered services. The customer name and the selected time prior may be entered into the service provider's reservation system as an expected customer. The dynamic income optimization system 20 preferably does not provide the service provider with the prepayment code, but rather may eventually validate a service provider's invoice based in part on whether the invoice includes the prepayment code associated with the voucher. Since the only way for the service provider to have obtained the prepayment code is from the customer at the time of rendering services associated with the voucher, an invoice from the service provider that include the prepayment code in association with the customer name may be sufficient proof that the service provider has provided the selected services. In embodiments that allow a customer to pay with a prepaid account or wallet, the voucher notification may be replaced with a simple reservation notice since a prepayment specific to this purchase has not been made. The reservation may be stored and transmitted to the service provider computing device in the same manner as a voucher notification, but may include a reservation code rather than a voucher code.

In embodiments where the customer has prepaid for a specific quantity of units, such as a number of seats in a restaurant, both the voucher transmitted to the customer computing device 60 and the voucher notification transmitted to the service provider computing device 50 may include the quantity of units. Having the quantity of units in the voucher will help the customer to remember how many guests may accompany them and having the quantity of units in the voucher notification will help the service provider to reserve sufficient service capacity for the customer. The voucher and voucher notification will preferably further include the face value of the voucher (i.e., how much value the customer will receive at the service provider) and the net prepaid amount (i.e., how much the customer actually paid for the voucher). In embodiments that allow a customer to pay with a prepaid account or wallet, the reservation sent to the customer computing device and the reservation notice sent to the service provider computing device may identify the quantity of units, but may not include a face value or net prepaid amount.

FIG. 5B is a process flow diagram illustrating interactions or steps between a customer and a service provider, optionally including operations of the customer computing device 60 and the service provider computing device 50. In step 7, the customer orders services from the selected service provider. If the customer wishes to receive the selected discount, the customer should be at the selected service provider, or otherwise make arrangements, to receive the selected services at the selected time period during which the selected price discount is applicable to the rendering of the selected offered services. In other words, the customer must meet the conditions set out in the voucher in order for the total prepaid purchase amount to be applied to the bill for services.

The service provider renders services to the customer in step 8 and presents a bill for the services to the customer in step 9. In step 10, the customer submits its voucher, or some portion of the voucher information, to the service provider in order for the total prepaid purchase amount to be applied to the amount of the bill. In some embodiments, the customer will provide the prepayment code to the service provider so that the service provider may later use the prepayment code as evidence that the service were actually rendered to the customer associated with the prepayment code. If the customer received the services during the selected time period, then the total prepaid purchase amount should to be applied to the amount of the bill. Accordingly, if the total prepaid purchase amount is greater than the amount of the bill, then the customer owes nothing except perhaps taxes and gratuity. However, if the total prepaid purchase amount is insufficient to cover the amount of the bill, then the customer must pay for the overage along with any additional taxes and gratuity.

Conversely, if the customer arrives at the wrong time and did not receive the services during the selected time period, then the customer may not benefit from the total prepaid purchase amount that was purchased at a discount. Rather, if the service provider is offering only a lower discount during the time period that the customer receives the services, then the total prepaid purchase amount may be adjusted downward to reflect the lower discount before being applied to the amount of the bill. For example, if the customer selected services at a 30% discount and paid $70 for a $100 total prepaid purchase amount, but received the services during a time period for which the service provider only offered a 20% discount, then the service provider may take a couple of optional actions. First, the service provider may turn the customer away on the basis that there is no available capacity at that time (i.e., the full capacity of the service provider has been reserved for other customers). Second, the service provider may adjust the amount of the discount to reflect the discount rate being offered at the current time. For example, the adjusted total purchase amount may equal the amount the customer paid for the voucher divided by the difference between 1 and the adjusted discount. In this example, $70/(1−0.2)=$87.50 adjusted total prepaid purchase amount. Accordingly, the adjusted total prepaid purchase amount is applied against the bill. Still, if the adjusted total prepaid purchase amount is greater than the amount of the bill, then the customer owes nothing except perhaps taxes and gratuity. However, if the adjusted total prepaid purchase amount is insufficient to cover the amount of the bill, then the customer must pay for the overage along with any additional taxes and gratuity.

It should be appreciated that some embodiments provide an incentive for a customer to purchase a prepaid voucher in order to achieve a discount on services. The customer should attempt to accurately estimate the total purchase amount (face value of the voucher) that they will spend at the service provider and make a prepayment equal to the total purchase amount less the discount. Underestimating the total purchase amount means that the customer will not receive the stated discount on the full amount of the bill, but overestimating the total purchase amount may mean that the customer's effective discount is less than the offered discount. Furthermore, the customer should attempt to select a time period that the customer and any planned guests can actually be available to receive the services. If the customer receives the services during a particular time period other than the selected time period, the amount of the amount of the discount may be adjusted such that the customer only benefits from the discount that is applicable to the particular time period.

In embodiments allowing a customer to use a prepaid account or wallet, the customer may pay the bill with their prepaid account rather than submitting a voucher in operation 10. For example, the customer may, at any time prior to payment, load funds into a prepaid account or wallet in operation 10A. When paying the service provider with a prepaid account, the service provider will seek a payment authorization from the dynamic income optimization system. If the customer has a prepaid account with a sufficient balance to cover the cost of the services, then the dynamic income optimization system may send a payment authorization to the service provider computing device in operation 10B. Optionally, the dynamic income optimization system may then place a “hold” on the customer's prepaid account in an amount equal to the amount being paid to the service provider.

It should also be appreciated that some embodiments provide an incentive for a service provider to submit allotments of services at discounts that still allow the service provider to cover at least their marginal costs of providing additional units of service and during time periods for which the service provider has idle capacity. If the service provider is able to make better use of their capacity, the service provider may increase their total profit.

FIG. 5C is a process flow diagram illustrating further operations of the dynamic income optimization system 20. In operation 11, the dynamic income optimization system 20 receives an invoice from the service provider computing device 50 of the selected service provider after the service provider has rendered services to the customer identified in the voucher notification (i.e., voucher notification in step 6 of FIG. 5A). The invoice identifies the service provider that rendered services to the customer and the customer. In some embodiments, the invoice may further identify an actual purchase amount of the offered services, and a time at which the customer received the services. Optionally, the service provider computing device 50 may generate a daily invoice including the details of every voucher that was redeemed by a customer that day. Still further, the daily invoice may report any customer that did not show up, which might lead to a penalty being assessed to the customer's account. Alternatively, if the service provider computing system 50 interfaces with, or includes, a point-of-sale system, the service provider computing system 50 may transmit, and the dynamic income optimization system 20 may receive, an invoice in response to a customer settling up their bill for services rendered. In embodiments that allow the customer to use a prepaid account or wallet, the service provider computing device will still submit an invoice and may reference a reservation and/or customer prepaid account identifier.

In operation 12, the dynamic income optimization system 20 may initiate payment to the service provider in response to receiving the invoice and reaching a positive determination that the service provider and the customer match the service provider and the customer identified in a stored voucher or reservation. Optionally, the payment might be further conditioned upon the time of service identified in the invoice matching and the time identified in the stored voucher. Alternatively, the dynamic income optimization system 20 may initiate payment to the service provider in response to receiving the invoice and reaching a positive determination that each transaction in the invoice includes a prepayment code and/or voucher/reservation code that matches a valid prepayment code and/or voucher/reservation code previously issued by a customer by the dynamic income optimization system 20. Optionally, the dynamic income optimization system 20 may initiate payment for any transaction in the invoice that accurately includes both a customer name and either a unique prepayment code or prepaid account number that is associated with the customer name in a voucher record stored by the dynamic income optimization system 20.

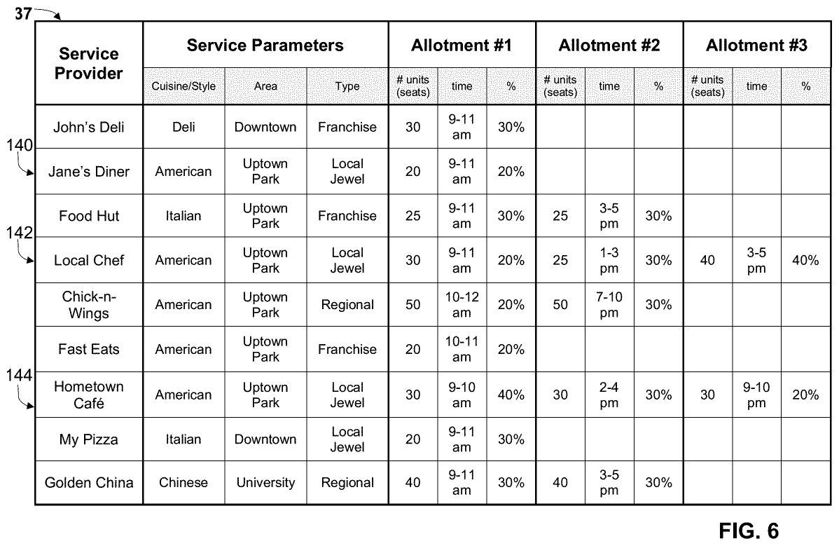

FIG. 6 is an illustration of one embodiment of the allotment records 37 that may be maintained by the dynamic income optimization system 20 as shown in FIG. 2. In this example, the allotment records 37 are illustrated in the form of a table having a number of rows and columns. However, it should be recognized that various other data structures are available for the storage of data such as the allotment records, and the illustration of a table is used here for convenience of disclosing the content of the allotment records 37 according to one embodiment. For example, the service parameters for a given service provider are not expected to change with each allotment, such that the service parameters may be stored in a separate data structure. Still, those service parameters may be searchable in associated with a given service provider to effect the same result as if the service parameters were included the allotment records 37 along with allotments of service.

In the illustration of FIG. 6, each column has a header that labels the content within individual cells of that column. Each individual cell may be considered to be a data field. Furthermore, each row defines an individual record having a plurality of data fields that are included in that record. The data fields within a row may be considered to be “associated” with the record or with each of the other data field within the record by virtue of being stored in the same record (row). Furthermore, other tables or other data structures may include records that are also “associated” with an individual record of the allotment records 37 if those records identify the same service provider. For example, a separate data structure may store service provider profile data for numerous service providers, where the profile data (i.e., an individual record within the service provider profile data) for a given service provider may be “associated” with an individual allotment record that is specific to the same service provider.

Each allotment record may be created and stored in the allotment records 37 as a result of a service provider using a service provider computing device to submit one or more allotment of services. The service provider preferably submits the one or more allotment of services to the allotment records 37 through the service provider interface. In the allotment records shown, each service provider has submitted only one allotment records, but it is possible for each service provider to submit multiple records in any number as needed.

The allotment records 37 includes nine allotment records, including an allotment record 140 for “Jane's Diner”, an allotment record 142 for “Local Chef”, and an allotment record 144 for “Hometown Café.” In reference to the allotment record 142 for “Jane's Diner”, the record identifies “Jane's Diner” in the service provider (column or field), “American” as the cuisine or style of service, “Uptown Park” as the area where the service provider is located, and “Local Jewel” as the type of service provider. The allotment record 142 for “Jane's Diner” further includes one allotment (Allotment #1) that includes 20 seats made available for a discount, 9:00-11:00 a.m. as the time that the discount is available, and 20% as the amount of the discount available.

Similarly, the allotment record 142 for “Local Chef” and the allotment record 144 for “Hometown Café” have the same cuisine/style, area and type fields as the allotment record 140 for “Jane's Diner.” However, the allotment record 142 for “Local Chef” and the allotment record 144 for “Hometown Café” have different allotments. Specifically, the allotment record 142 for “Local Chef” has three allotments, including Allotment #1 with 30 seats from 9-11 a.m. at a 20% discount, 25 seats from 1-3 p.m. at a 30% discount, and 40 seats from 3-5 p.m. at a 40% discount.

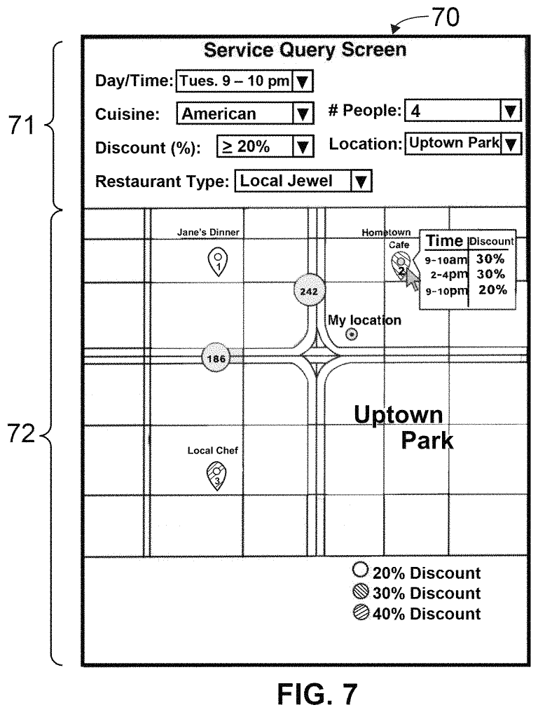

The allotment records 37 may be searched or queried by a customer or potential customer in order to identify a service provider providing a desired service. The process of querying the allotment records 37 is discussed below in reference to FIG. 7.

FIG. 7 is an illustration of a graphical user interface (GUI) 70 generated by the dynamic income optimization system 20 for displaying a service query screen on a customer computing device 60. The graphical user interface 70 includes a first section 71 for a customer to select input for a query. In this example, the first section 71 includes a set of drop down lists, wherein each drop down list represents one parameter for the query and allows the customer to select a value for the parameter or leave the parameter blank so that the parameter is not part of the query. As shown, the customer may select values for the parameters of day/time, cuisine, discount (%), restaurant type, number of people, and distance from the customer's current location. In the example shown, the customer has selected values from the drop down lists to query for Tuesday, between 9 am and 10 pm, American cuisine, greater than or equal to a 20% discount, local jewel restaurant type, seating for 4 people, at a location in Uptown Park. This is a very specific search, but a second section 72 of the graphical user interface 70 displays the search results in the form of a map showing the locations of three restaurants that satisfy the search parameters. This single map view quickly and easily communicates to the customer that he/she can purchase a discount voucher that meets the search parameters at any of three service providers: (1) Jane's Diner is offering a 20% discount (one colored border around the map location icon; also see the legend); (2) Hometown Café is offering a maximum discount of 30% (a colored border around the icon indicating the maximum discount; also see the legend); and (3) Local Chef is offering a maximum discount of 40% discount (a colored border around the icon indicating the maximum discount; also see the legend). Based on the customer's interest in any of the three service providers, selecting or hovering a pointer over one of the icons may display a pop-up box showing an allotment of services, such as the specific time period during which each offered discount is available. Here, the customer has used a pointing device (see selection arrow) to select the Hometown Café icon, such that a pop-up box shows that the 30% discount is being offered between 9-10 am and between 2-4 pm, and the 20% discount is being offered between 9-10 pm. The customer may interact with the map to select other icons and review allotments of services until a decision is made to purchase a prepaid discount voucher or perform another query using different search parameters.

FIGS. 8-13 illustrate a voucher purchase that includes a reservation at a restaurant. FIG. 8 is an illustration of a graphical user interface 80 generated by the dynamic income optimization system 20 for displaying a voucher purchase screen on a customer computing device 60. Accordingly, the customer may use the voucher purchase screen to review and/or modify the details of a proposed prepaid voucher prior to a final submission or payment.

The graphical user interface 80 includes a first section 81 with information about the customer and a second section 82 with details about the voucher, discount and selected service provider. An optional third section 83 is provided to show the customer his purchase history 84 at the selected service provider and provide a helpful tool 85 for suggesting a total purchase amount. Optionally, a pair of selection buttons may be used to allow the customer to select between their own history at the service provider or others' history at the service provider. The suggested purchase amount is based in part on the selected time period of the voucher and may also be based on either the user's own purchase history or the purchase history of other users at the selected surface provider. A further section 86 shows the customer's selected prepayment face value (total prepaid purchase amount), the discount to be applied, a processing fee and the total prepayment due. In one option, the user may edit the customer name and contact numbers in the first section 81, which may be used to purchase a voucher in another person's name. When the customer is satisfied with the details on the voucher purchase screen, a “submit” button 87 may be selected to initiate a checkout process for authorizing a payment.

FIG. 9 is an illustration of a graphical user interface 90 generated by the dynamic income optimization system 20 for displaying a voucher on a customer computing device 60. The graphical user interface 90 is provided after the dynamic income optimization system 20 confirms receipt of payment. The voucher 90 details may be saved in a customer's voucher wallet for future reference and use in paying for services at the selected service provider. The content of the voucher may vary, but may include the finalized details of the voucher purchase screen shown in FIG. 8, such as a voucher code or reservation code, the customer name, prepayment face value, discount applied, the name/address/phone of the selected service provider, the day/time of the voucher/reservation, and the number of people included in the voucher/reservation. Note however, that the graphical user interface 90 for the voucher further includes a unique prepayment code 91. In some embodiments, the customer may provide the unique prepayment code to the service provider for purpose of providing evidence that the customer received the services and credit for the prepayment face value on the customer's bill. In one option, the voucher 90 may include a barcode, such as a QR code, that is associated with the voucher information. Accordingly, a service provider may scan the code and automatically upload the voucher information from the dynamic income optimization system or from the service provider's own records of voucher notifications.

FIG. 10 is an illustration of a voucher notification 100 transmitted from the dynamic income optimization system 20 to the service provider computing device 50 to notify the service provider about a voucher that has been issued to a customer. In this example, the voucher notification identifies the customer's name, the number of people included in the voucher/reservation, the prepayment face value (total prepaid discount purchase amount), the discount applied, and the selected time and number of people for which the customer is making a reservation. The voucher notification may further include the voucher/reservation code and/or the prepayment code associated with the voucher. The service provider may use this information to make a reservation for the customer in the service provider computing device, or the service provider may have an interface with dynamic income optimization system to receive the voucher notification information in an electronic file or record that can be uploaded to its system.

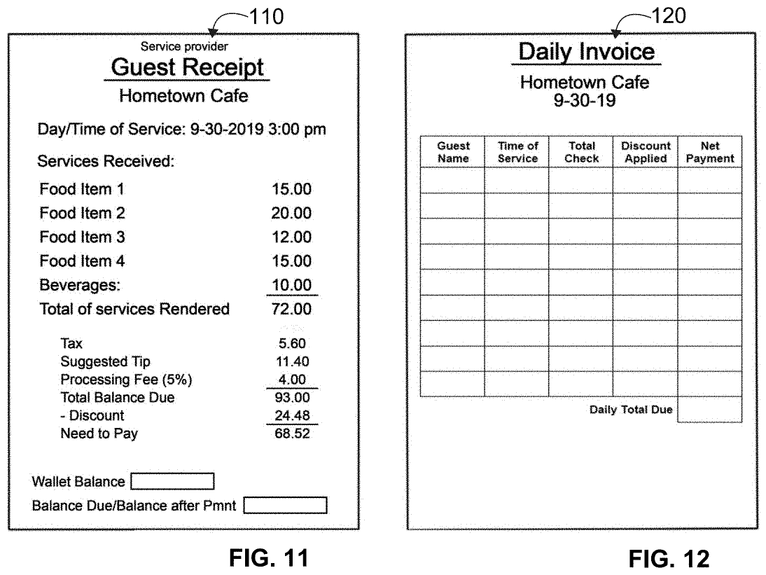

FIG. 11 is an illustration of a guest receipt 110 issued by the service provider computing device 50 to the customer after service has been rendered and paid in full. In this example, the total of services is $72.00, such that the entire prepayment face value of $60.00 is subtracted from the bill. However, there is remaining balance such the balance due after tax and gratuity is $29.00. The guest receipt further shows that the customer paid the balance due with a credit card such that the customer's bill for services was paid in full.

FIG. 12 is an illustration of an invoice 120 received by the dynamic income optimization system 20 from the service provider computing device 50. In this example, the invoice 120 is a daily invoice, presumably issued after the close of business for the day and including a record (illustrated as a row in the table) for each guest transaction that involved a prepayment. Each guest transaction my identify the guest/customer name, time of service, total check amount, the discount applied, and the net payment. Each transaction record on the invoice may, in some embodiments, further identify a prepayment code that the customer tendered to the service provider.

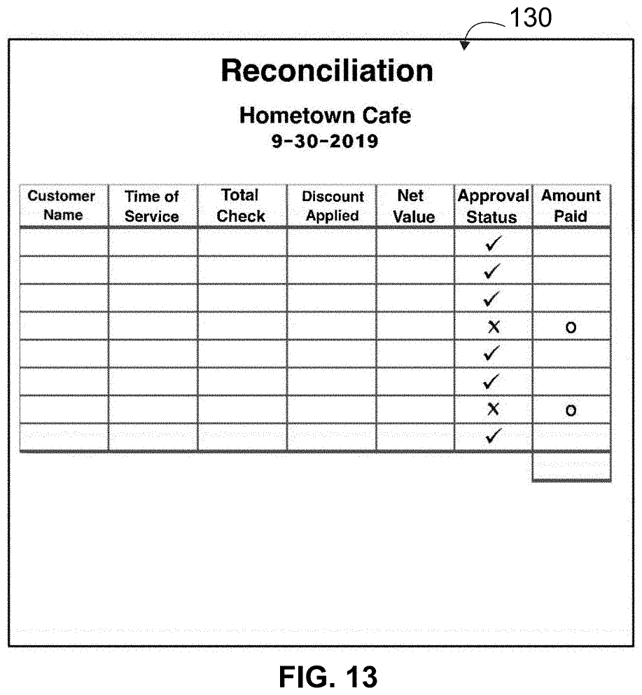

FIG. 13 is an illustration of a reconciliation statement 130 generated by the dynamic income optimization system 20 and provided to the service provider computing device 50 to explain how a payment amount has been calculated. In this example, the reconciliation statement includes a row for each prepayment transaction that was included in the invoice 120 of FIG. 12. The reconciliation statement 130 then includes an additional column for the “approval status” of that prepayment transaction.

The dynamic income optimization system 20 may consider the prepayment code to be evidence that the customer received services from the service provider, and the prepayment amount may be approved (indicated here by a check mark) for payment to the service provider in response to finding a stored and unredeemed voucher in the voucher records of the discount voucher system 20 that includes both the prepayment code and the guest name. Upon approval of the payment to the service provider, the related voucher(s) are marked as having been redeemed and are no longer valid. Furthermore, if the combination of the prepayment code and the customer name from a prepayment transaction in the invoice are not found in any of the voucher records of the dynamic income optimization system 20, then the payment to the service provider may be disapproved (indicated here by an “X”).

While the reconciliation statement may be focused on the accounting issue of how much money has been approved for payment to the service provider, some embodiments may further provide the service provider with a production report. The production report may show all vouchers or a total of all vouchers issued during a specified time period.

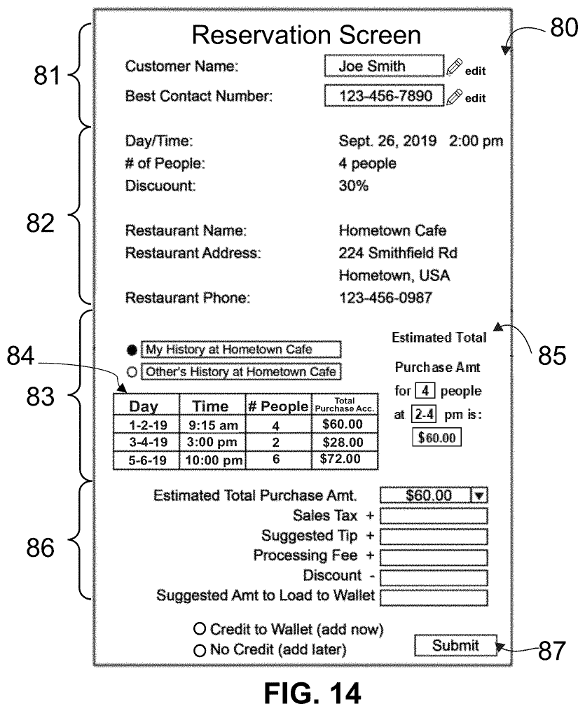

FIGS. 14-19 illustrate a reservation at a restaurant that will be paid for with a customer's prepaid account or wallet. FIG. 14 is an illustration of a graphical user interface 80 generated by the dynamic income optimization system computing device 20 for displaying a reservation screen on a customer computing device 60. Accordingly, the customer may use the reservation screen to review and/or modify the details of a proposed reservation prior to a final submission. Furthermore, the reservation screen may include a tool to help the customer determine how much money should be loaded in their prepaid account or wallet.

The graphical user interface 80 includes a first section 81 with information about the customer and a second section 82 with details about the reservation, discount and selected service provider. An optional third section 83 is provided to show the customer his purchase history 84 at the selected service provider and provide a helpful tool 85 for suggesting a total purchase amount. Optionally, a pair of selection buttons may be used to allow the customer to select between their own history at the service provider or others' history at the service provider. The suggested purchase amount is based in part on the selected time period of the reservation and may also be based on either the user's own purchase history or the purchase history of other users at the selected surface provider. A further section 86 shows the customer's estimated total purchase amount, sales tax, suggested tip, processing fee, and the discount to be applied, and a suggested amount to load into the customer's prepaid account or wallet. In one option, the user may edit the customer name and contact numbers in the first section 81, which may be used to make a reservation in another person's name. When the customer is satisfied with the details on the reservation screen, a “submit” button 87 may be selected to submit the reservation and/or initiate a checkout process for authorizing additional funds to be loaded to the customer's prepaid account or wallet.

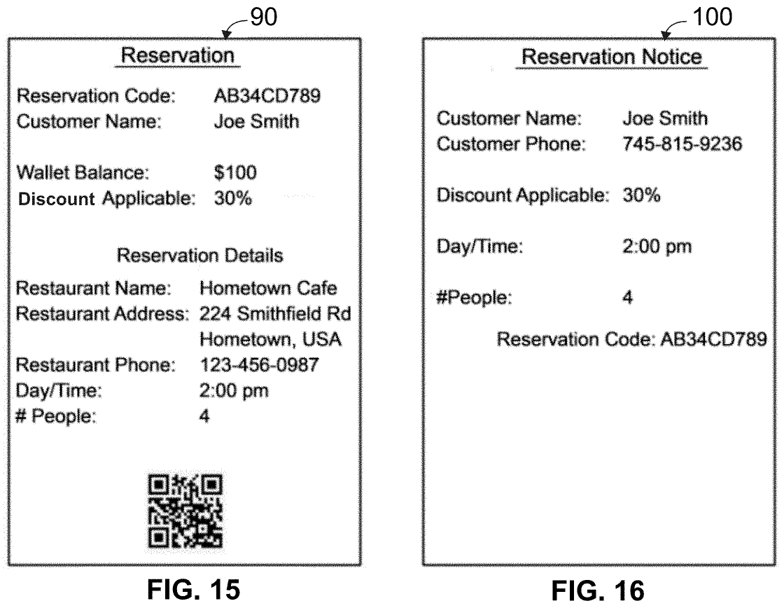

FIG. 15 is an illustration of a graphical user interface 90 generated by the dynamic income optimization system computing device for displaying a reservation on a customer computing device 60. The graphical user interface 90 is provided after the dynamic income optimization system 20 confirms a reservation. The reservation details may be saved in a customer's reservation wallet or calendar for future reference and use at the selected service provider. The content of the reservation may vary, but may include the finalized details of the reservation screen shown in FIG. 14, such as the customer name, discount applicable, the name/address/phone of the selected service provider, the day/time of the voucher/reservation, and the number of people included in the voucher/reservation. The reservation may also include a reservation code and prepaid account or wallet balance. In one option, the voucher 90 may include a barcode, such as a QR code, that is associated with some or all of the reservation information. Accordingly, a service provider may scan the code and automatically upload the reservation details and/or customer prepaid account identifier from the dynamic income optimization system or from the service provider's own records of reservations and customer history.

FIG. 16 is an illustration of a reservation notice 100 transmitted from the dynamic income optimization system computing device 20 to the service provider computing device 50 to identify a customer and the selected time at which the customer has made a reservation. In this example, the reservation notice identifies the customer's name and phone number, the discount applicable, and the selected day, time and number of people for which the customer is making a reservation. The reservation notice may further include the reservation code. The service provider may use this information to make a reservation for the customer in the service provider computing device, or the service provider may have an interface with dynamic income optimization system to receive the reservation notice in an electronic file or record that can be uploaded to its system.

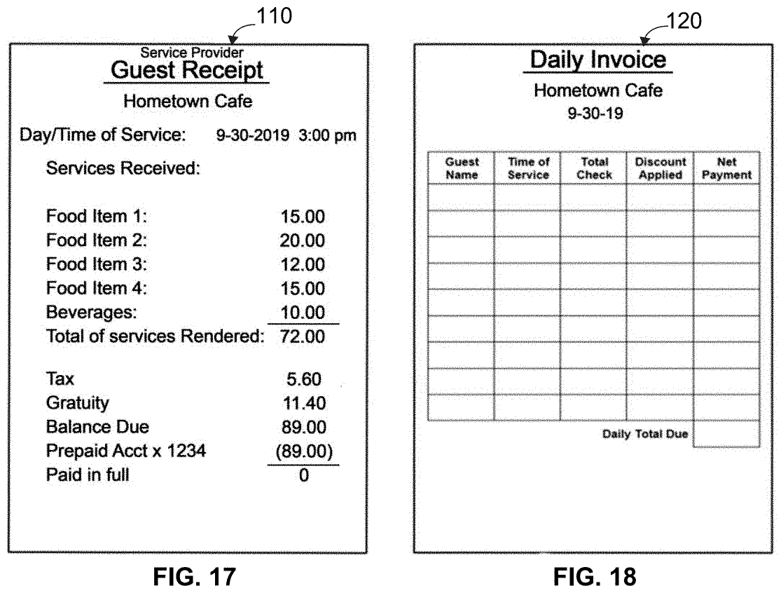

FIG. 17 is an illustration of a service provider guest receipt 110 issued by the service provider computing device 50 to the customer after service has been rendered and paid in full. In this example, the total of services is $72.00, such that the balance due after tax and gratuity is $89.00. The guest receipt further shows that the customer paid the balance due with their prepaid account or wallet such that the customer's bill for services was paid in full. However, the service provider will subsequently receive invoice the dynamic income optimization system for the $89 and receive the $89 payment from the customer's prepaid account with the dynamic income optimization system.

FIG. 18 is an illustration of an invoice 120 received by the dynamic optimization system 20 from the service provider computing device 50. In this example, the invoice 120 is a daily invoice, presumably issued after the close of business for the day and including a record (illustrated as a row in the table) for each guest transaction that involved payment using a customer's prepaid account or wallet. Each transaction record on the invoice may, in some embodiments, further identify the customer's prepaid account number that the customer tendered to the service provider. Although no data is shown, the invoice illustrates the content that would be included and reported to the dynamic income optimization system.

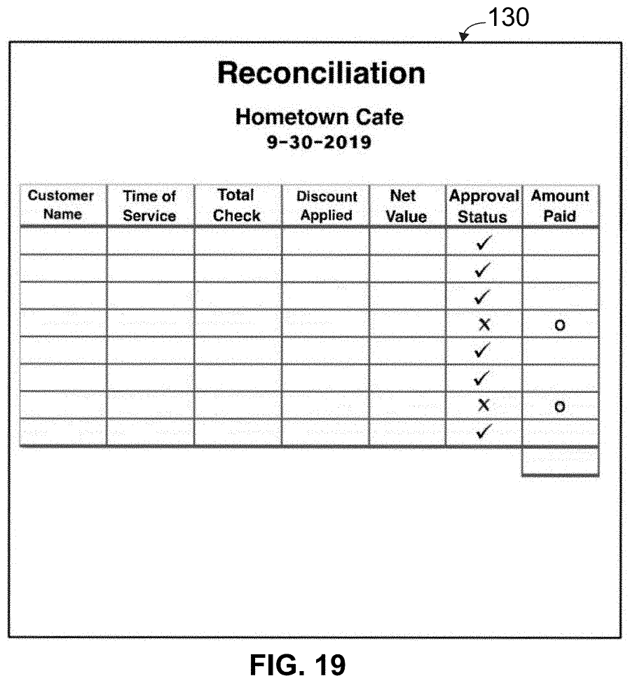

FIG. 19 is an illustration of a reconciliation statement 130 generated by the dynamic income optimization system 20 and provided to the service provider computing device 50 to explain how a payment amount has been calculated. In this example, the reconciliation statement includes a row for each prepayment transaction that was included in the invoice 120 of FIG. 12. The reconciliation statement 130 then includes an additional column for the “approval status” of that prepayment transaction. Although no data is shown, the invoice illustrates the content that would be included and reported to the service provider computing device. While the reconciliation statement may be focused on the accounting issue of how much money has been approved for payment to the service provider, some embodiments may further provide the service provider with a production report. The production report may show all reservations or a total of all reservations issued during a specified time period.

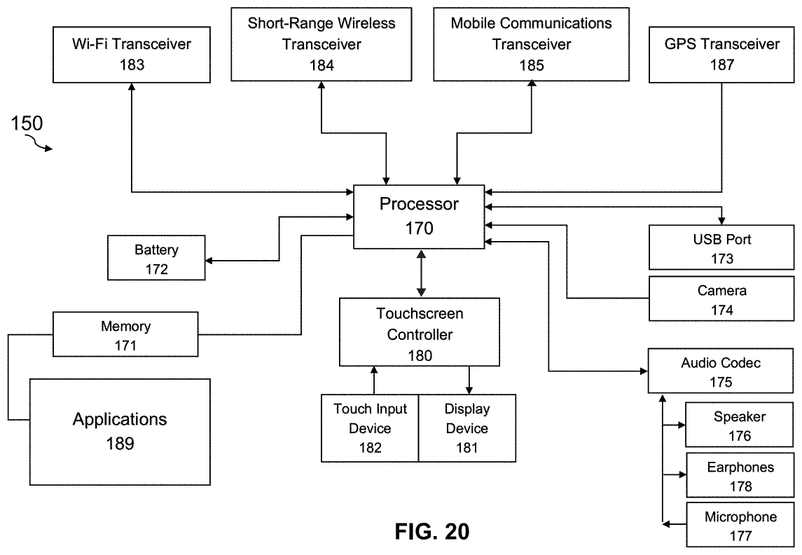

FIG. 20 is a diagram of a computing device 150, such as a smartphone, that may form a short-range wireless connection with the communication network 14 shown in FIG. 1. The computing device 150 may be representative of some embodiments of a service provider computing device 50 or a customer computing device 60, although the architecture and functionality may vary.

The computing device 150 may include a processor 170, memory 171, a battery (or other power source) 172, a universal serial bus (USB) port 173, a camera 174, and an audio codec 175 coupled to a built-in speaker 176, a microphone 177, and an earphone jack 178. The computing device 150 may further include a touchscreen controller 180 which provides a graphical output to the display device 181 and an input from a touch input device 182. Collectively, the display device 181 and touch input device 182 may be referred to as a touchscreen.

The computing device 150 may also include a short-range wireless transceiver 184, a wireless local area network transceiver (“Wi-Fi transceiver”) 183, a mobile communication transceiver 185 for communication with a cellular communication network, and a global positioning system (GPS) transceiver 187.

The memory 171 may store one or more applications 189 including program instructions that are executable by the processor 170. Where the computer 150 is representative of, or used to implement, the service provider computing device 50, the application programs 189 may include the modules illustrated in FIG. 3. Where the computer 150 is representative of, or used to implement, the customer computing device 60, the application programs 189 may include the modules illustrated in FIG. 4.

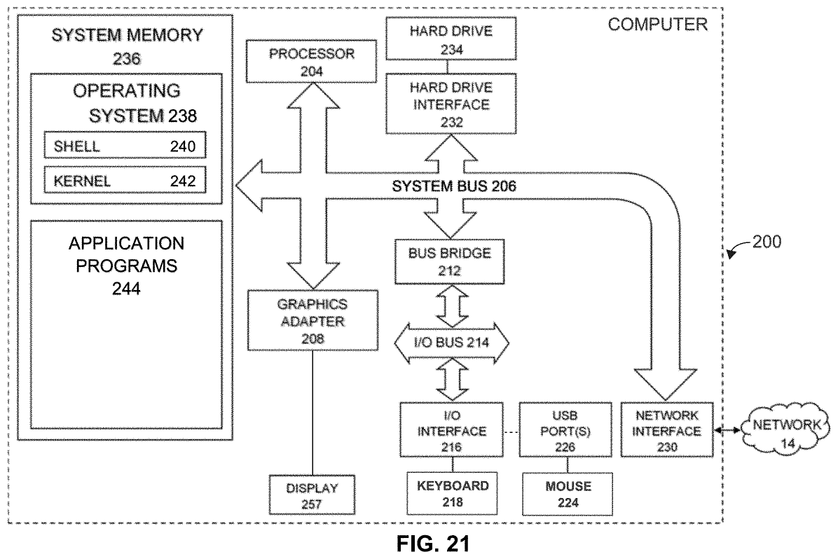

FIG. 21 is a diagram of one embodiment of a computer 200 that may serve as the dynamic income optimization system 20, the service provider computing device 50 and/or the customer computing device 60 of FIG. 1. The computer 200 includes a processor unit 204 that is coupled to a system bus 206. The processor unit 204 may utilize one or more processors, each of which has one or more processor cores. A graphics adapter 208, which drives/supports the display 257, is also coupled to system bus 206. The graphics adapter 208 may, for example, include a graphics processing unit (GPU). The system bus 206 is coupled via a bus bridge 212 to an input/output (I/O) bus 214. An I/O interface 216 is coupled to the I/O bus 214. The I/O interface 216 affords communication with various I/O devices, including a keyboard 218 (either a physical keyboard or a touch screen virtual keyboard), and a USB mouse 224 via USB port(s) 226 (or other type of pointing device, such as a trackpad). As depicted, the computer 200 is able to communicate with other network devices over the network 14 using a network adapter or network interface controller 230. For example, the computer 200 may communicate with the dynamic income optimization system 20 for submitting queries and purchasing prepaid discount vouchers.

A hard drive interface 232 is also coupled to the system bus 206. The hard drive interface 232 interfaces with a hard drive 234. In a preferred embodiment, the hard drive 234 communicates with system memory 236, which is also coupled to the system bus 206. System memory is defined as a lowest level of volatile memory in the computer 200. This volatile memory includes additional higher levels of volatile memory (not shown), including, but not limited to, cache memory, registers and buffers. Data that populates the system memory 236 includes the operating system (OS) 238 and application programs 244. The hardware elements depicted in the computer 200 are not intended to be exhaustive, but rather are representative. For instance, the computer 200 may include non-volatile memory and the like.

The operating system 238 includes a shell 240 for providing transparent user access to resources such as application programs 244. Generally, the shell 240 is a program that provides an interpreter and an interface between the user and the operating system. More specifically, the shell 240 executes commands that are entered into a command line user interface or from a file. Thus, the shell 240, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while the shell 240 may be a text-based, line-oriented user interface, embodiments may support other user interface modes, such as graphical, voice, gestural, etc.

As depicted, the operating system 238 also includes the kernel 242, which includes lower levels of functionality for the operating system 238, including providing essential services required by other parts of the operating system 238 and application programs 244. Such essential services may include memory management, process and task management, disk management, and mouse and keyboard management.

As shown, the computer 200 includes application programs 244 in the system memory of the computer 200. Where the computer 200 is representative of, or used to implement, the dynamic income optimization system 20, the application programs 244 may include the modules illustrated in FIG. 2. Where the computer 200 is representative of, or used to implement, the service provider computing device 50, the application programs 244 may include the modules illustrated in FIG. 3. Where the computer 200 is representative of, or used to implement, the customer computing device 60, the application programs 244 may include the modules illustrated in FIG. 4.

In some embodiments, such as a second embodiment, a customer may purchase a voucher that is not restricted to use at a particular date and time (i.e., no reservation is made). Rather, the voucher may be used at any time, but the amount of the discount will vary according to the time period in which the voucher is used or presented for services provided by a service provider. In order to encourage the customer to buy the voucher in a greater prepayment amount, the amount of purchase that benefits from the discount may be limited to the purchase value of the voucher, which varies according to the time period in which the voucher is eventually used (redeemed). Some of the previously described embodiments stored vouchers that the customer had to use at a particular date and time, essentially during a set reservation, in order to receive the discount. In those previous embodiments, if the customer received service from the identified service provider at a time other than the particular date and time specified by the voucher, then the discount may not be honored. However, in the present embodiment, the voucher may be used at any time without a reservation and the voucher identifies a plurality of discounts, wherein each discount is associated with a unique time period during which the discount may be applied to the purchase of goods or services. Accordingly, the voucher allows the customer purchasing the voucher to lock in a set of potential discounts, yet it is the time that the customer actually purchases and receives services from the service provider that ultimately determines which discount, from among the set of potential discounts, will be applied to the purchase. This embodiment is particular well-suited for use with service providers that do not accept reservations.

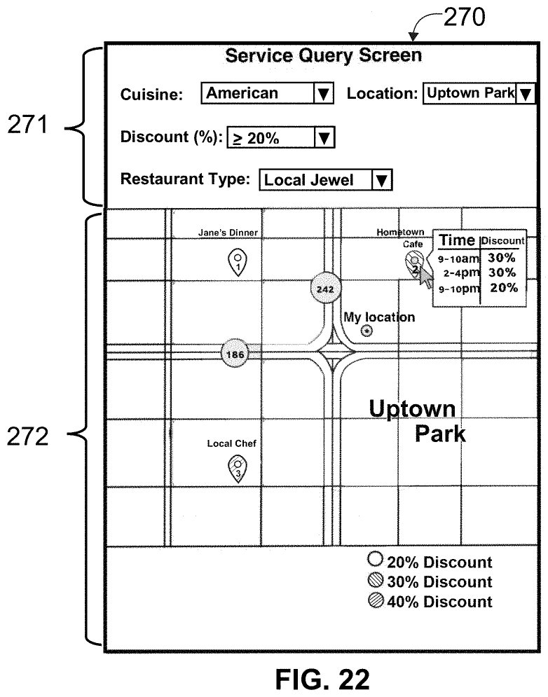

Embodiments that involve vouchers with a plurality of discounts, wherein each discount is associated with a unique time period during which the discount may be applied to the purchase of goods or services, may be implemented in a manner consistent with FIGS. 1-6. In one non-limiting example, FIGS. 22-25 are provided to illustrate minor modifications of FIGS. 7-10.

FIG. 22 is an illustration of a graphical user interface 270 generated by the dynamic income optimization system for displaying a service query screen on a customer computing device according to a second embodiment. The graphical user interface 270 includes a first section 271 for a customer to select input for a query. In this example, the first section 271 includes a set of drop down lists, wherein each drop down list represents one parameter for the query and allows the customer to select a value for the parameter or leave the parameter blank so that the parameter is not part of the query. As shown, the customer may select values for the parameters of cuisine, discount (%), restaurant type, and location of the service provider. In the example shown, the customer has selected values from the drop down lists to query for American cuisine, greater than or equal to a 20% discount, local jewel restaurant type, at a location in Uptown Park. This is a very specific search, but a second section 272 of the graphical user interface 270 displays the search results in the form of a map showing the locations of three restaurants that satisfy the search parameters. This single map view quickly and easily communicates to the customer that he/she can purchase a discount voucher that meets the search parameters at any of three service providers: (1) Jane's Diner is offering a 20% discount (one colored border around the map location icon; also see the legend); (2) Hometown Café is offering a 20% discount and 30% discount (two colored borders around the map location icon; also see the legend); and (3) Local Chef is offering a 20% discount, 30% discount, and 40% discount (three colored borders around the map location icon; also see the legend). Based on the customer's interest in any of the three service providers, selecting or hovering over one of the icons may display a pop-up box showing an allotment of services, such as the specific time period during which each offered discount is available. Here, the customer has used a pointing device (see selection arrow) to select the Hometown Café icon, such that a pop-up box shows that the 40% discount is being offered between 9-10 am, the 30% discount is being offered between 2-4 pm, and the 20% discount is being offered between 9-10 pm. However, the actual discount that the customer receives will depend upon the day/time that the customer uses the voucher to obtain services from the service provider. The customer may interact with the map to select other icons and review allotments of services until a decision is made to purchase a prepaid discount voucher or perform another query using different search parameters.

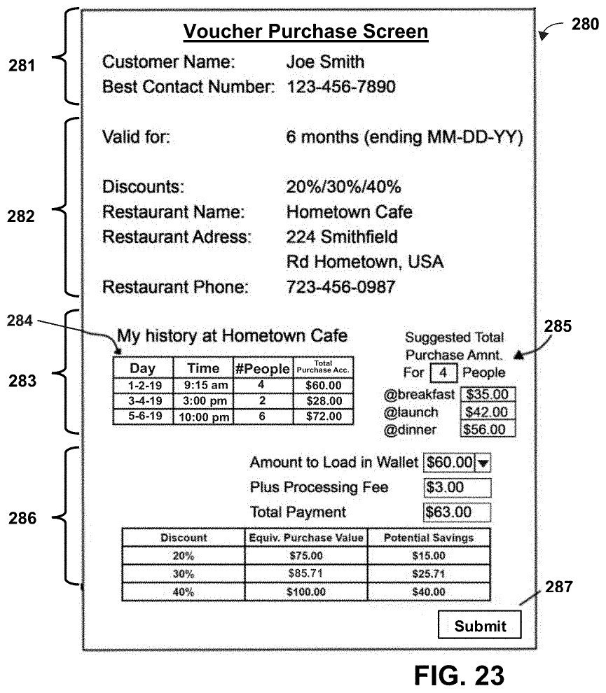

FIG. 23 is an illustration of a graphical user interface 280 generated by the dynamic income optimization system 20 for displaying a voucher purchase screen on a customer computing device 60 according to a second embodiment. Accordingly, the customer may use the voucher purchase screen to review and/or modify the details of a proposed prepaid voucher prior to a final submission or payment.

The graphical user interface 280 includes a first section 281 with information about the customer and a second section 282 with details about the voucher, discount and selected service provider. An optional third section 283 is provided to show the customer his purchase history 284 at the selected service provider and provide a helpful tool 285 for suggesting a total purchase amount. The suggested purchase amount is based in part on the selected time period of the voucher and may also be based on either the user's own purchase history or the purchase history of other users at the selected surface provider. A further section 286 shows the customer's selected prepayment amount (total prepaid purchase amount), a processing fee and the total prepayment due. Section 286 may further includes a table showing the various available discount levels, an equivalent purchase value and potential savings that the customer will obtain if spending the prepayment amount at each discount level. When the customer is satisfied with the details on the voucher purchase screen, a “submit” button 287 may be selected to initiate a checkout process for authorizing a payment.

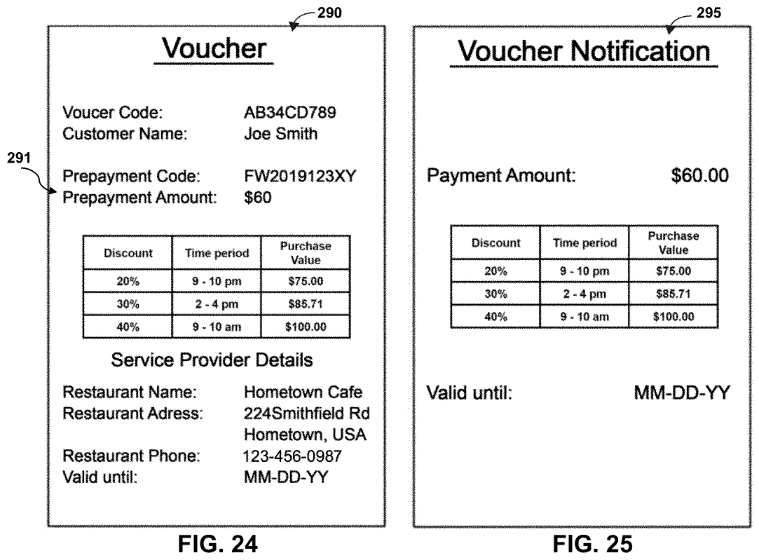

FIG. 24 is an illustration of a graphical user interface 290 generated by the dynamic income optimization system 20 for displaying a voucher on a customer computing device 60 according to a second embodiment. The graphical user interface 290 is provided after the dynamic income optimization system 20 confirms receipt of the total payment. The voucher 290 details may be saved in a customer's voucher wallet for future reference and use in paying for services at the selected service provider. The content of the voucher may vary, but may include the finalized details of the voucher purchase screen shown in FIG. 17, such as a voucher code, the customer name, the date the voucher was purchased, a prepayment code that is unique to the payment received, and the prepayment amount. The voucher 290 may further include a table describing each of the available discounts, a time period during which each available discount is offered, and a purchase value that may be realized using the prepayment amount at each discount level. Still further, the voucher 290 may include various service provider details, such as the name/address/phone of the selected service provider where the voucher may be redeemed. Optionally, the voucher may also have an expiration date after with the voucher is no longer valid. Note however, that the graphical user interface 290 for the voucher further includes a unique prepayment code 291. In some embodiments, the customer may provide the unique prepayment code to the service provider such that the service provider may subsequently submit the prepayment code to the dynamic income optimization system as evidence that the customer received the services and received credit for the prepayment face value on the customer's bill. In other words, the prepayment code may be used for the service provider to seek payment from the dynamic income optimization system.

FIG. 25 is an illustration of a voucher notification 295 transmitted from the discount voucher computing 20 system to the service provider computing system 50 to notify the service provider about a voucher that has been issued to a customer according to a second embodiment. In this example, the voucher notification identifies the prepayment amount (total prepaid discount purchase amount); information describing each of the discounts available, a time period during which each discount may be redeemed, and a purchase value that may be realized using the prepayment amount at each discount level; and an expiration date. The service provider may receive the voucher notification information in an electronic file or record that can be uploaded to its system.

As with other embodiments, the customer will eventually obtain services from the service provider and redeem the voucher by submitting at least the prepayment code to the service provider. The service provider may then submit an invoice to the dynamic income optimization system, wherein the invoice includes the prepayment code. After the dynamic income optimization system receives the invoice with the prepayment code, the dynamic income optimization system may initiate payment to the service provider in response to receiving the invoice and reaching a positive determination that the prepayment code identified in the invoice is a valid prepayment code. In one option, a prepayment code is valid if it has not been previously redeemed.

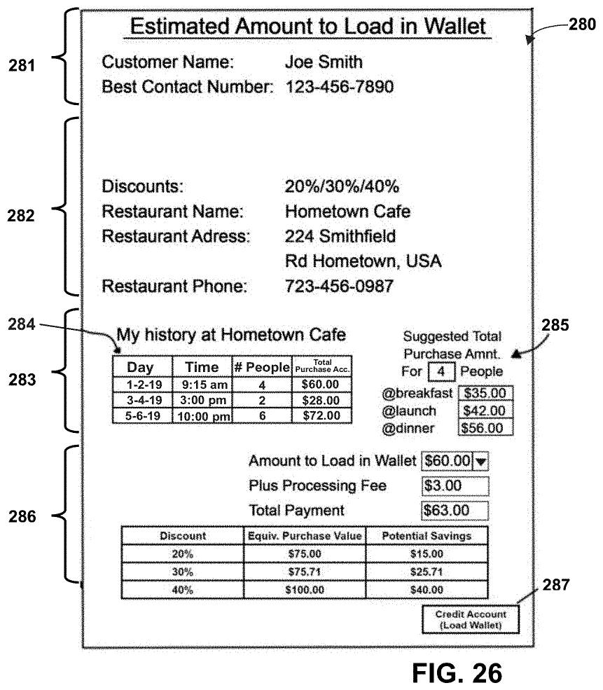

In embodiments that allow a customer to use a prepaid account or wallet, it may be unnecessary to have any of the previously disclosed voucher purchase screens, voucher screens, voucher notifications, etc. Rather, the customer may make a reservation and manage their prepaid account balance from a single screen as shown in FIG. 26.

FIG. 26 is an illustration of a graphical user interface 280 generated by the dynamic income optimization system computing device 20 for displaying on a customer computing device 60 an estimated amount of money to load in the customer's wallet according to a second embodiment. Accordingly, the customer may use the interface to determine how much money they should have and/or put into their prepaid account or wallet that is maintained with the dynamic income optimization system.

The graphical user interface 280 includes a first section 281 with information about the customer and a second section 282 with details about the reservation, discount and selected service provider. An optional third section 283 is provided to show the customer his purchase history 284 at the selected service provider and provide a helpful tool 285 for suggesting an amount to load into the customer's prepaid account or wallet. The suggested/estimated amount is based in part on the selected time period of the reservation and may also be based on either the user's own purchase history or the purchase history of other users at the selected surface provider. A further section 286 shows an amount to upload to the prepaid account or wallet as well as a processing fee and a total payment amount. Section 286 may further includes a table showing the various available discount levels, an equivalent purchase value and potential savings that the customer will obtain if spending the total payment amount at each discount level. When the customer is satisfied with the details on the screen, a “credit account” button 287 may be selected to initiate a checkout process for authorizing a payment that will load additional fund into their prepaid account or wallet.

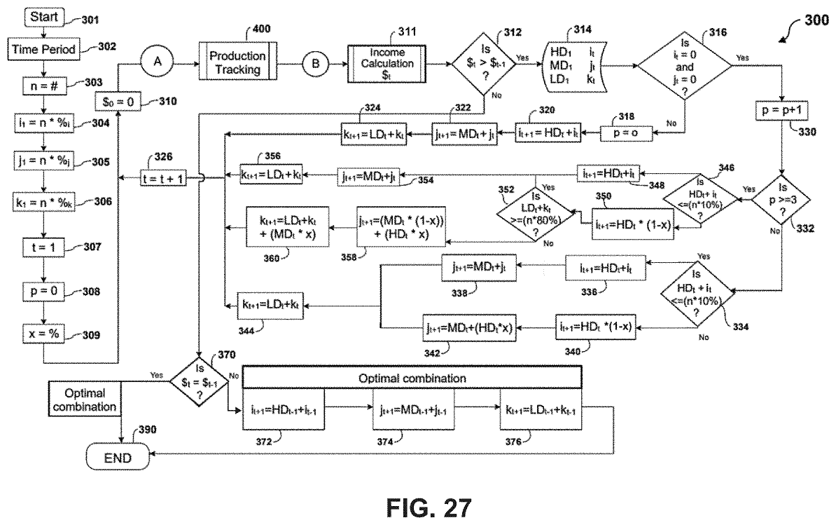

FIG. 27 is a flowchart that describes an allocation service that the dynamic income optimization system may provide to one or more of the service provider computing devices. The service may use production data, such as amounts of sales and income, received from the service provider in order to help the service provider determine how to allot units of their services among a plurality of discounts in order to increase their income. In other words, the dynamic income optimization system may recommend that the service provider make allotments of services among various levels of discounts in order to increase the service provider's income over time. Optionally, the service provider may grant permission for the dynamic income optimization system to automatically and/or periodically modify the service provider's allotments of services.

FIG. 27 is a flowchart of an embodiment of a method for modifying allotments of services among a plurality of discounts in order increase income for the service provider. In general, the method may include an initial phase in which the values of certain variables are initialized, established and/or input by a user. For example, the total inventory of units may be quantified and allocated among a plurality of discounts. After the initial phase, a series of steps and determinations may be repeatedly executed, as in a loop of operations, during various predetermined time periods. Each predetermined time period may be independently selected from a particular week of the month or year, a particular day or days of the week, a particular hour or hours of the day, and/or other chosen time periods. Such predetermined time periods may be individually determined for each service provider or type of service provider, perhaps reflecting known or expected differences in demand for the services, and a sequence of time periods may be of the same or different durations. For example, demand for services of the service provider may depend upon the service provider's location relative to commercial office space, the service provider's location relative to residential customers, the type or nature of the services offered by the service provider, and other characteristics unique to the service provider. A restaurant (service provider) that is located in a commercial office building with a large number of office workers may experience a high demand for lunch service during the week, but much lower demand for breakfast and dinner services during week and all meals over the weekend. A similar restaurant located near residential customers may experience high demand for breakfast and dinner during the week, as well as high demand for lunch and dinner over the weekend.

Some embodiments of the method may be performed using the allotment and production data from a particular one of the various predetermined time periods. In the example of restaurant, such predetermined time periods may include breakfast hours, mid-morning hours, lunch hours, mid-afternoon hours, dinner hours, after dinner hours, and/or days of the week, etc. in order to increase income during each time period by determining an allotment of discount services for that time period. Specifically, if a restaurant is at maximum capacity during lunch hours each day during the week, there may be less incentive to offer a high discount during lunch hours during the week. However, the lower demand during breakfast hours, dinner hours, or weekends may respond to discounts, and any increase in demand resulting from the discounts may differ during each of these time periods. The method may use an iterative process to modify allotments of service among a plurality of discounts to increase the service provider's income as customer demand for services responds to the discounts.

The method may, under certain conditions, decrease a number of units allotted to a first (higher) discount and increase a number of units allotted to a second (lower) discount. Furthermore, the method may, under certain other conditions, increase a number of units allotted to a first (higher) discount and decrease a number of units allotted to a second (lower) discount. Still further, since the method may be used to optimize income in each of the predetermined time periods independent of the other time periods, it is possible that a number of units allotted to a given discount may be increased during one time period (say, a lunch period during the weekend) and that a number of units allotted to the given discount may be decreased during another time period (say, a lunch period during the week). Similarly, since the method may be used to optimize income on an ongoing basis (i.e., continuously or periodically over the life of the service provider), it is possible that, for each of the predetermined time periods, a number of units allotted to a particular discount may vary over time. For example, if the demand during a lunch period during the weekend is low during summers and holidays, then the method may recommend an increase in the number of units allotted to a first (higher) discount during summers and holidays, while the method may recommend a decrease in the number of units allotted to the first (higher) discount during periods other than summers and holidays. It should also be recognized that the method may modify allocation of units to various discount as a result of changes in other variables, such as population growth and changes in the services offered.

The flowcharts of FIGS. 27-31 use certain variables that are defined as follows:

Time Period—a predetermined time period (day/hours of the day) during which income is to be optimized.

n—total number of units of service available for discount.

t—the number of a current sequential instance of the predetermined Time Period (designated in operation 302) that is being evaluated.

iₜ—number of units of service allotted/available at a high discount (HD) during instance t of the Time Period.

jₜ—number of units of service allotted/available at a medium discount (MD) during instance t of the Time Period.

kₜ—number of units of service allotted/available at a low discount (LD) during instance t of the Time Period.

%ᵢ, %ⱼ and %ₖ—initial percentage of total units of service available for discount that are allocated to the high discount, medium discount and low discount, respectively.

p—an integer value used as a counter.

x—a percentage value that is used to calculate a number of units of service to shift from one discount to another discount during any one instance of the Time Period.

$ₜ—amount of income earned during instance t of the Time Period.

HDₜ—number of units sold at a high (first) discount during instance t of the Time Period.

MDₜ—number of units sold at a medium (second) discount during instance t of the Time Period.

LDₜ—number of units sold at a low (third) discount during instance t of the Time Period.

FIG. 27 is a flowchart of a method 300 for modifying an allocation of services among a plurality of discounts to optimize income for a given service provider. The method may be implemented as a computer program product comprising a non-volatile computer readable medium and non-transitory program instructions embodied therein, where the program instructions are configured to be executable by a processor to cause the processor to perform the operations of the method. Furthermore, the method or computer program product may be performed by either the dynamic income optimization system 20 or the service provider computing device 50.

While the notation of variables used in method 300 does not expressly call out a given service provider, each of the variables in the method 300, and the performance of the method 300, is specific to a given service provider. If the dynamic income optimization system performs the method 300 for a plurality of service providers, a separate instance of the method 300 may be independently performed or executed for each service provider on the same or different processors either simultaneously, consecutively, or without any regard to the timing of other instances of the method.

Since the method may involve a sequence of operations that use data representing actual transactions that occur over time, some operations, or entire loops of operations, may have to wait for subsequent data to become available. Therefore, the values of certain variables used in the method may be saved to memory device or to a data storage device until needed for the processing of subsequent operations.

The method 300 is illustrated, without limitation, to include four main sections or modules. A first section includes operations 301-310 and may be referred to as an initialization section, where the order of the initialization operations may be changed without effect. In this first section, variables are initiated or defined and may be given initial values. A second section includes operation 400, which is shown in greater detail in FIG. 21 and may be referred to as a sales or production tracking module. A third section includes operation 311, which may be referred to as an income calculation or query module. A fourth section include the remaining operations in FIG. 20, which may be referred to as an allocation recommendation module.

The method 300 begins at the Start, labeled as operation 301, and finishes with End, labeled as operation 390. It should be understood that the method 300 may be run any number of times, for any one or more Time Period, and for any number of service providers. Accordingly, the Start and End operations could, in some embodiments, be considered Resume and Pause operations, respectively. For example, the method may run continuously, periodically, at scheduled times, or upon request.

In operation 302, a Time Period is designated. For example, the Time Period may be a month, week, day, day of the week, hour or hour range during the day or any specific day, and the like. However, this Time Period is designated by the service provider or a representative of the dynamic income optimization system (on behalf of the service provider) as a period during which income is to be optimized. Preferably, a plurality of Time Periods are designated for a given service provider, where each Time Period is characterized by a relatively constant set of conditions. For example, if a restaurant has a strong lunch time crowd of customers from 11:00 am to 1:00 pm each Friday, then this may be designated as one Time Period, whereas a weak demand period from 2:00 pm to 4:00 pm may also be designated as another Time Period. As another example, a service provider may provide an allocation of services to various discounts and designate a Time Period to be an entire month or other length of time in which to determine whether or not the allocation increased their income.

In operation 303, a total number of units of service available for discount (“n”) is provided or input. For example, the units of service may be the full or partial capacity of a restaurant measured in a number of seats or tables, the full or partial capacity of a rental car agency measured in a number of automobiles, the full or partial capacity of a hotel measured in a number of rooms, and/or the full or partial capacity of a cleaning service measured in person-hours. In operations 304, 305 and 306, %ᵢ, %ⱼ and %ₖ are designated, respectively, to enable the calculation of i₁, j₁ and k₁, respectively. In some embodiments, %ᵢ+%ⱼ+%ₖ may equal 1.

In operation 307, t is given an initial value of 1, where t is the number of a current sequential instance of the predetermined Time Period (designated in operation 302) that is being evaluated. For example, if the Time Period is a daily breakfast seating at a diner (say, 6:00 am to 9:00 am), then the value oft may increase each day when the breakfast seating period has ended and the production data for that instance of the Time Period has been input into the method.

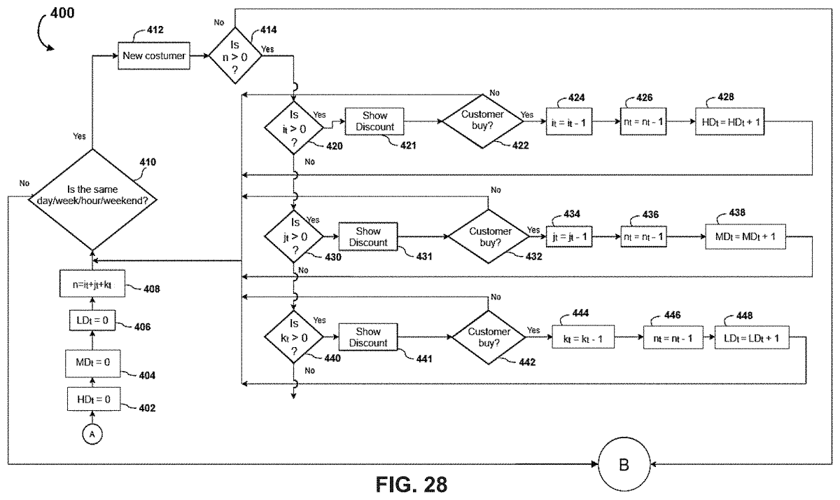

In operation 308, an initial integer value of 0 is designated for the variable p, which is used as a counter. In operation 309, a value for x is designated, where x is a percentage value that is used to calculate a number of units of service to shift from one discount to another discount during any one instance of the Time Period. For example, if there are 10 units of service allotted to a high discount and x is 20%, then the method may, under appropriate conditions, incrementally shift 2 units (i.e., 10 units*20%) of service into or out of the high discount allotment following any one Time Period. In operation 310, an initial value for the service provider's income ($) at time t=0 is set to zero ($₀=0). After operation 310, the method 300 proceeds to the production tracking operation or sub-process 400, which is shown in FIG. 28. Note that the points “A” and “B” indicate where method 300 jumps to and from operation 400.

In FIG. 28, the production tracking operation 400 begins at point “A” (from method 300) and ends at point “B” (returning to method 300). After point “A”, the operation 400 sets the value of HDₜ=0 in operation 402, sets the value of MDₜ=0 in operation 404, and sets the value of LDₜ=0 in operation 406. In operation 408, the method 400 inherits the values of n, iₜ, jₜ, and kₜ from method 300, either the initial values set in operations 303-306 or the derived values subsequently calculated in other operations of method 300.

Operation 410 determines whether the current time is still within the Time Period designated in operation 302. For example, if the Time Period designated in operation 302 is a daily breakfast seating at a diner (say, 6:00 am to 9:00 am), then the operation 410 leads to the “Yes” branch only between 6:00 am and 9:00 am. During any other time of day, the operation 410 would lead to the “No” branch that leads to point “B” which returns to FIG. 20. Operation 412 recognizes or detects that a customer computing device may have requested information about the discounts offered by the service provider. So, operation 414 determines whether n>0 (i.e., whether there are any of the n allotted units of service still available at a discount). If there are not remaining units of service available at a discount, then operation 400 follows the “No” branch to point “B” which returns to FIG. 20. However, if there are in fact some units of service still available at a discount, then operation 400 follows the “Yes” branch to operations that determine which discounts are available.

Operation 420 determines whether iₜ>0 (i.e., whether any of the iₜ allotted units of service still available at the High Discount). If operation 420 determines that there are no units of service are still available at the High Discount (i.e., iₜ=0; a sold out condition), then the “No” branch is followed to operation 430. Operation 430 determines whether jₜ>0 (i.e., whether any of the jₜ allotted units of service are still available at the Medium Discount). If operation 430 determines that there are no units of service still available at the Medium Discount (i.e., jₜ=0; a sold out condition), then the “No” branch is followed to operation 440. Operation 440 determines whether kₜ>0 (i.e., whether any of the kₜ allotted units of service are still available at the Low Discount). If operation 440 determines that there are no units of service still available at the Low Discount (i.e., kₜ=0; a sold out condition), then operation 440 follows the “No” branch to point “B” which returns to FIG. 20. In one option, operation 440 may be eliminated, such that the “No” branch from operation 430 lead directed to operation 441. The elimination of operation 440 is possible because if n>0 (i.e., some positive number of units are available) in operation 414, yet both iₜ (the number of units available at a High Discount) and jₜ (the number of units available at a Medium Discount) are 0, then the available units of service (“n”) must be available at the Low Discount (i.e., kₜ=n). In other words, the method has already made sufficient determinations to know that kₜ>0 without making a separate determination in operation 440.

However, if operation 420 determines that there are units of service still available at the High Discount (i.e., iₜ>0), then the “Yes” branch is followed to operation 421, where the number of units of service available and the associated level of discount are shown to the customer. Operation 422 then determines whether or not the customer purchases a discount voucher for a unit of service at the High Discount. If the customer does not purchased a discount voucher, then the “No” branch is followed to return to operation 410. However, if the customer does purchased a discount voucher, then the “Yes” branch is followed to operation 424 where iₜ=iₜ−1 (i.e., the number of available units of service at the High Discount is decreased by 1), then operation 426 where n=n−1 (i.e., the number of available units of service at any Discount is decreased by 1), and then operation 428 where HDₜ=HDₜ+1 (i.e., the number of units of service sold at the High Discount is increased by 1) before returning to operation 410.

Similarly, if operation 430 determines that there are units of service still available at the Medium Discount (i.e., jₜ>0), then the “Yes” branch is followed to operation 431, where the number of units of service available and the associated level of discount are shown to the customer. Operation 432 then determines whether or not the customer purchases a discount voucher for a unit of service at the Medium Discount. If the customer does not purchased a discount voucher, then the “No” branch is followed to return to operation 410. However, if the customer does purchased a discount voucher, then the “Yes” branch is followed to operation 434 where jₜ=jₜ−1 (i.e., the number of available units of service at the Medium Discount is decreased by 1), then operation 436 where n=n−1 (i.e., the number of available units of service at any Discount is decreased by 1), and then operation 438 where MDₜ=MDₜ+1 (i.e., the number of units of service sold at the Medium Discount is increased by 1) before returning to operation 410.

Still further, if operation 440 determines that there are units of service still available at the Low Discount (i.e., kₜ>0), then the “Yes” branch is followed to operation 441, where the number of units of service available and the associated level of discount are shown to the customer. Operation 442 then determines whether or not the customer purchases a discount voucher for a unit of service at the Low Discount. If the customer does not purchased a discount voucher, then the “No” branch is followed to return to operation 410. However, if the customer does purchased a discount voucher, then the “Yes” branch is followed to operation 444 where kₜ=kₜ−1 (i.e., the number of available units of service at the Low Discount is decreased by 1), then operation 446 where n=n−1 (i.e., the number of available units of service at any Discount is decreased by 1), and then operation 448 where LDₜ=LDₜ+1 (i.e., the number of units of service sold at the Low Discount is increased by 1) before returning to operation 410.

The overall operation 400 continues to loop through the production tracking operations until either operation 410 determines that the current time is no longer within the Time Period or operation 414 determines that there are no more of the n allotted units of service still available (i.e., n is not greater than 0). Upon negative determinations in either of operations 410 or 414, operation 400 goes to point “B” which returns to FIG. 20.

After the production tracking operation 400 returns to point “B”, method 300 proceeds to an income determination or calculation operation 311. The income determination or calculation operation 311 may be performed by the service provider computing device 50 of FIG. 1, perhaps by a separate accounting or operations software package. Accordingly, operation 311 may simply include receiving an income value for the present Time Period. While the goal of offering discount vouchers to customers may be to maximize the profits of the service provider, the method 300 has been simplified to maximize the income of the service provider. Maximizing the income of the service provider should also maximize the profits of the service provider so long as the offered discounts (i.e., the High Discount, Medium Discount and Low Discount) are set at levels where the service provider is still assured of making some positive amount of profit, or at least not losing money, on each unit of service sold. For example, if the service provider has a 50% profit on each breakfast meal sold, the service provider will preferably not offer a discount that is any greater than 50%.

Operation 312 determines whether $ₜ>$ₜ₋₁. This determination identifies whether or not the income in the present instance t of the Time Period is greater than the income during the immediately prior instance of the Time Period. If operation 312 reaches a positive determination (i.e., $ₜ>$ₜ₋₁), then the operation 314 obtains the values of HDₜ, MDₜ, LDₜ, iₜ, jₜ and kₜ from the performance of the production tracking operation 400 for the present instance of the Time Period. The values of these variables from the present instance of the Time Period may be used in the subsequent operations to determine values of iₜ₊₁, jₜ₊₁ and kₜ₊₁ to be used in the next instance of the Time Period.

Operation 316 determines whether iₜ=0 and jₜ=0. In other words, operation 316 determines whether the service provider sold out of all of the units allotted to both the High Discount (i.e., iₜ=0) and the Medium Discount and (jₜ=0). If operation 316 reaches a negative determination, then method 300 follows the “No” branch to operation 318 where the value of p is set to zero, operation 320 where iₜ₊₁=HDₜ+iₜ (such that the allotment iₜ₊₁ of units to the High Discount for the next instance of the Time Period will remain the same as in the previous allotment iₜ for the previous instance of the Time Period). Note that at the end of each Time Period (see operation 400 in FIG. 21), the values of HDₜ, MDₜ, and LDₜ represent the number of units sold from each discount level and the values of iₜ, jₜ and kₜ represent the number of units from each discount level that were not sold. So, the operation of iₜ₊₁=HDₜ+iₜ means that the next allocation of units of service to the High Discount is equal to the number of units sold from the High Discount allotment plus the number of units from the High Discount allotment that were not sold. The result is that the allotment to the High Discount stay the same for the next instance of the Time Period. Operation 322 performs a similar calculation jₜ₊₁=MDₜ+jₜ for the Medium Discount and operation 324 performs a similar calculation kₜ₊₁=LDₜ+kₜ for the Low Discount. Essentially, if operation 316 determines that the High Discount and Medium Discount units were not sold out, then the allocation of units to the High Discount and Medium Discount remain the same. After the operations 318, 320, 322, 324, operation 326 increments the value of t by 1 (i.e., t=t+1) before performing the production tracking operation 400 again for the next instance of the Time Period.

However, if operation 316 determines that iₜ=0 and jₜ=0 (i.e., a positive determination that the service provider sold out of all of the units allotted to both the High Discount (i.e., iₜ=0) and the Medium Discount and (jₜ=0)), then method 300 follows the “Yes” branch to operation 330 where the value of p is incremented by 1.

Operation 332 determines whether p≥a setpoint value, such as 3. Since p is initiated with the value of 0 in operation 308, p won't have a value greater than or equal to 3 until operation 316 has made a positive determination three times. So, when p=1 or 2, operation 332 will reach a negative determination and the method will follow the “No” branch to operation 334. Operation 334 determines whether HDₜ+iₜ≤n*10%. Since HDₜ+iₜ is the entire current allocation to the High Discount (either sold or not sold in the last instance of the Time Period) and since n is the total number of units allocated to discount services, operation 334 determines whether the current allocation to the High Discount has reach a level that is 10% or less of the entire allocation n. This determination reflects a policy that prefers to always maintain at least some minimum allocation of services to the High Discount. The value of 10% may be modified to reflect preferences for a different level of minimum allocation to the High Discount. If operation 334 reaches a positive determination, then the method follows the “Yes” branch to operations 336, 338 where the allocation to the High Discount is kept the same (i.e., iₜ₊₁=HDₜ+iₜ) and the allocation to the Medium Discount is kept the same (i.e., jₜ₊₁=MDₜ+jₜ), respectively.

If operation 334 reaches a negative determination, then the method follows the “No” branch to operations 340, 342 where the allocation to the High Discount is reduced by x percent (i.e., iₜ₊₁=HDₜ*(1−x))) and the allocation to the Medium Discount is increased by the same amount as the decrease in the allocation to the High Discount (i.e., jₜ₊₁=MDₜ+(HD*x), respectively. From either of operations 338, 342, operation 344 then keeps the allocation to the Low Discount the same (i.e., kₜ₊₁=LDₜ+kₜ) before proceeding to operation 326.

If operation 332 reaches a positive determination (i.e., p>3), then the method will follow the “Yes” branch to operation 346. Operation 346 determines whether HDₜ+iₜ≤n*10% (similar to the determination in operation 334). If operation 346 reaches a positive determination, then the method follows the “Yes” branch to operation 348 where the allocation to the High Discount is kept the same (i.e., iₜ₊₁=HDₜ+iₜ), before proceeding to operation 354. However, if operation 346 reaches a negative determination, then the method follows the “No” branch to operation 350 where the allocation to the High Discount is reduced by x percent (i.e., iₜ₊₁=HDₜ*(1−x))). From operation 350, the method proceeds to operation 352.

Operation 352 determines whether LDₜ+kₜ>n*80%. Since LDₜ+kₜ is the entire current allocation to the Low Discount (either sold or not sold in the last instance of the Time Period) and since n is the total number of units allocated to discount services, operation 352 determines whether the current allocation to the Low Discount has reach a level that is 80% or greater of the entire allocation n. This determination reflects a policy that prefers to always maintain at least some minimum allocation of services to the High Discount (optionally 10%) and the Medium Discount (optionally 10%), such that the allocation of services to the Low Discount would not exceed 80%. These values may be modified to reflect preferences for a different level of minimum allocation to each discount. If operation 352 reaches a positive determination, then the method follows the “Yes” branch to operations 354, 356 where the allocation to the Medium Discount is kept the same (i.e., jₜ₊₁=MDₜ+jₜ) and the allocation to the Low Discount is kept the same (i.e., kₜ₊₁=LDₜ+kₜ), respectively. However, if operation 352 reaches a negative determination, then the method follows the “No” branch to operations 358, 360. In operation 358, the allocation to the Medium Discount is reduced by x percent (i.e., jₜ₊₁=MDₜ*(1−x))). In operation 360, the allocation to the Low Discount is increased by the same amount as the decrease in the allocation to the Medium Discount (i.e., jₜ₊₁=MDₜ+jₜ), respectively. From either of operations 356, 360, the method proceeds to operation 326.

If operation 312 determines that the income in the present instance t of the Time Period is not greater than the income during the immediately prior instance of the Time Period, then the method follows the “No” branch to operation 370. Operation 370 determines whether $ₜ=$ₜ₋₁. If operation 370 reaches a positive determination, then the income is optimal and the allocation of units of service among the High Discount, Medium Discount and Low Discount is considered to be an optimal combination. If operation 370 reaches a negative determination, then the income $ₜ at the current instance of the Time Period is actual less than $ₜ₋₁ at the previous instance of the Time Period. Accordingly, operations 372, 374, 376 return the allocations back to the allocations that were previously in place during the previous instance of the Time Period where the income was $ₜ₋₁. Operation 372 sets iₜ₊₁=HDₜ₋₁+iₜ₋₁, operation 374 sets jₜ₊₁=MDₜ₋₁+jₜ₋₁, and operation 376 sets kₜ₊₁=LDₜ₋₁+kₜ₋₁. This allocation may then be considered to be the optimal combination of discount and yield the optimal income.

The method 300 may be repeated from time to time to verify that the optimal combination has not changed. In one option, a subsequent performance of method 300 may initiate the values of i₁, j₁ and k₁, respectively, with the same values as these variables had at the end of the previous performance of method 300. In this manner, the method 300 may begin with an allocation that was previously determined to be optimal. Modifications in the allocation among the discounts may begin from there.

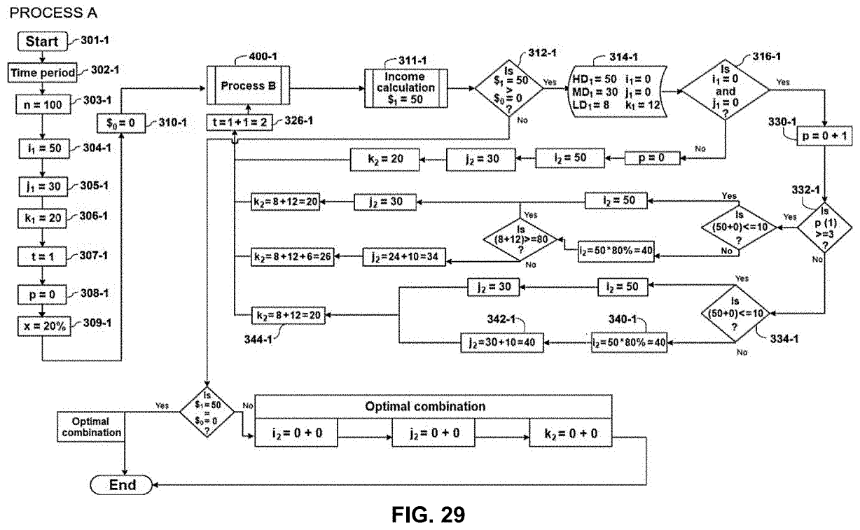

FIGS. 29-32C provide an example of the performance of method 300 using some specific values. Using these specific values and some assumptions about the resulting income, the method 300 arrives at an optimal allocation in five iterations of the Time Period. The operation 400 corresponding to FIG. 28 is not shown in detail because the customer sales resulting from the production tracking operation 400 is merely being assumed according to this example. The reference numbers for the operations include the reference numbers of method 300 from FIG. 27, but with a dash and a number representing the number of instances of the Time Period. Furthermore, the path of the flowchart in each of FIGS. 22-27 is highlighted to illustrate how the method flows through the operations.

FIG. 29 shows specific values for the variables initialized in operations 302-1 through 309-1. Note that the initial allocation (50/30/20) of n=100 units during instance t includes 50 units for the High Discount (i.e., iᵢ=50), 30 units for the Medium Discount (i.e., j₁=30) and 20 units for the Low Discount (i.e., k₁=20). The production tracking operation 400-1 yields the values shown in operation 314-1. While the initial income is $₀=0, the income calculation in operation 311-1 determines an income of 50 in instance t=1 (i.e., $₁=50). So, the “Yes” branch from operation 312-1 is followed to use the values in operation 314-1 in subsequent operations. Since the High Discount and Medium Discount units are determined to be sold out in operation 316-1, then operation 330-1 increments p to a value of 1. Operation 332-1 determines that the current value of p (p=1) is not greater than or equal to 3, so the “No” branch is followed to operation 334-1. Since operation 334-1 determines that the current number of units available at the High Discount (50) is not less than 10 (10=100*10%), the “No” branch is followed to operation 340-1 to reduce the number of units allocated to the High Discount to 40 (50*(1−20%)), operation 342-1 to increase the number of units allocated to the Medium Discount by the same amount as the decrease in units of the High Discount (30+(50*20%)=40), and operation 344-1 to keep the Low Discount allocation at 20. Next, the value of t is incremented from 1 to 2 in operation 326-1, and then the method loops back around, beginning at operation 400-2 in FIG. 23.

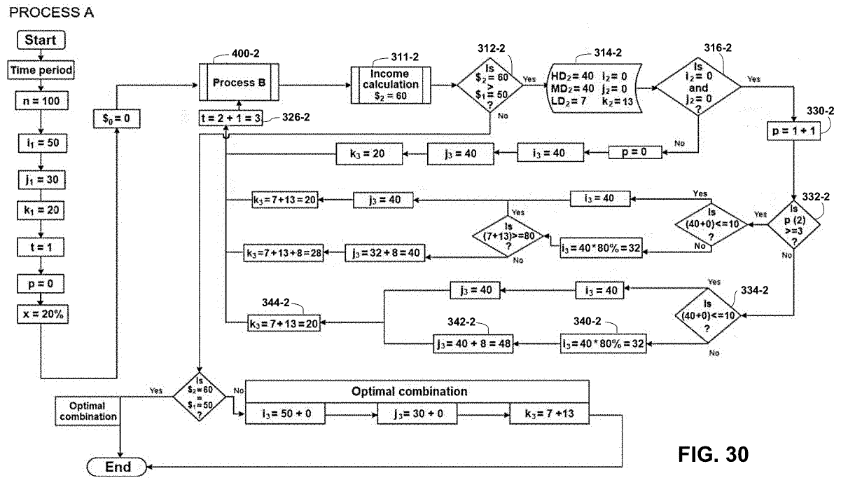

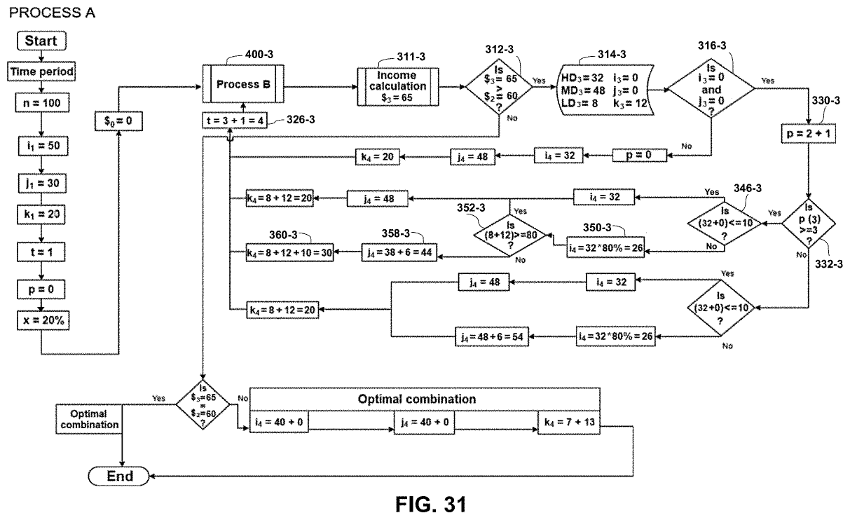

FIG. 30 performs the same operations as in FIG. 29, except for the initialization operations. However, with a modified allocation (40/40/20) going into the production tracking operation 400-2, the income calculation 311-2 returns a value of 60 and the production tracking operation 400-2 returns the values in operation 314-2. Since the income of 60 is greater than the previous income of 50, and since the High Discount and Medium Discount units are again determined to be sold out in operation 316-2, operation 330-2 increments p to a value of 2. Operation 332-2 determines that the current value of p (p=2) is not greater than or equal to 3, so the “No” branch is followed to operation 334-2. Since operation 334-2 determines that the current number of units available at the High Discount (40) is not less than 10 (10=100*10%), the “No” branch is followed to operation 340-2 to reduce the number of units allocated to the High Discount to 32 (40*(1−20%)), operation 342-2 to increase the number of units allocated to the Medium Discount by the same amount as the decrease in units of the High Discount (40+(40*20%)=48), and operation 344-2 to keep the Low Discount allocation at 20. Next, the value oft is incremented from 2 to 3, and then the method loops back around, beginning at operation 400-3 in FIG. 31.

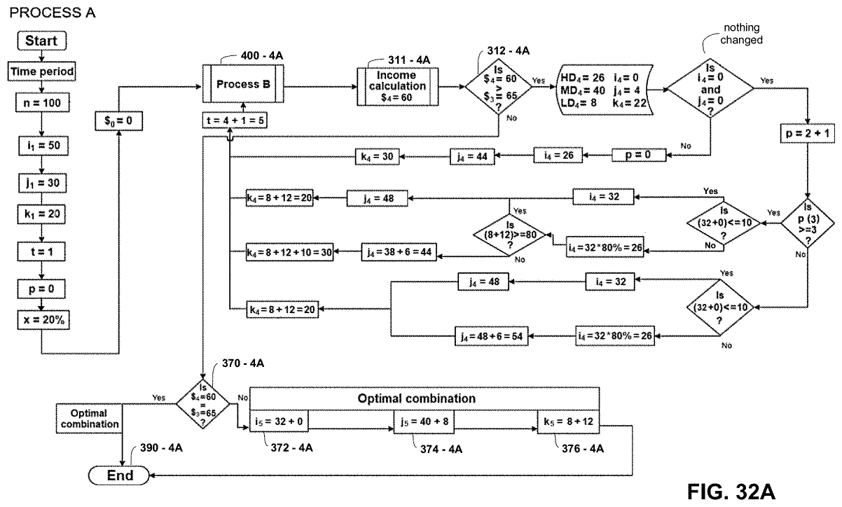

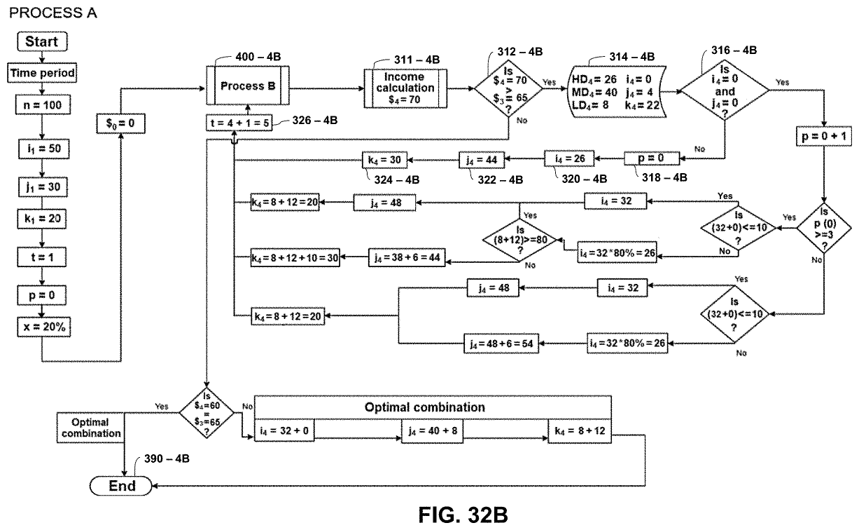

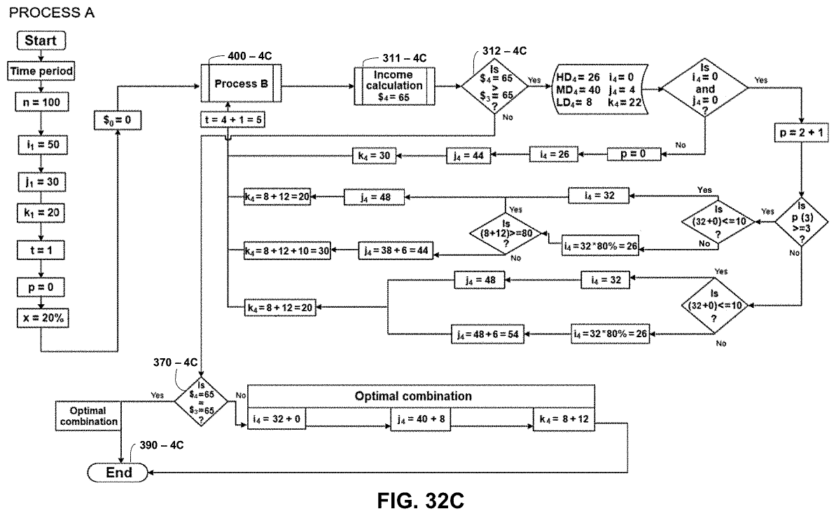

FIG. 31 performs some of the same operations as in FIG. 29 prior to taking the “Yes” branch from operation 332-3. With a further modified allocation (32/48/20) going into the production tracking operation 400-3, the income calculation 311-3 returns a value of 65 and the production tracking operation 400-3 returns the values in operation 314-3. Since the income of 65 is greater than the previous income of 60, and since the High Discount and Medium Discount units are again determined to be sold out in operation 316-3, operation 330-3 increments p to a value of 3. Operation 332-2 determines that the current value of p (p=3) is equal to 3, so the “Yes” branch is followed to operation 346-3. Since operation 346-3 determines that the current number of units available at the High Discount (32) is not less than 10 (10=100*10%), the “No” branch is followed to operation 350-3 to reduce the number of units allocated to the High Discount to 26 (32*(1−20%)). Operation 352-3 then determines that 20 units allocated to the Low Discount is not greater than or equal to 80, such that the “No” branch is followed to operation 358-3 to modify the number of units allocated to the Medium Discount to 44 ((48*0.8)+(32*0.2)=44) and operation 360-3 to increase the number of units allocated to the Low Discount by 20% of the previous units in the Medium Discount to 30. Next, the value of t is incremented from 3 to 4 in operation 326-3, and then the method loops back around, beginning at operation 400-4 in FIG. 32.

FIGS. 32A-32C each perform the production tracking operation 400-4 based on the further modified allocation (26/44/30), but illustrate three different possible outcomes. FIG. 32A illustrates an income of 60 that is lower than the previous income of 65, FIG. 32B illustrates an income of 70 that is greater than the previous income of 65, and FIG. 32C illustrates an income of 65 that is equal to the previous income of 65.

In the illustration of FIG. 32A, the income calculation 311-4A returns a value of 60. Since the income of 60 is not greater than the previous income of 65, the method follows the “No” branch from operation 312-4A to operation 370-4A. Since operation 370-4A determines that the current income of 60 is not equal to the previous income of 65, then the “No” branch is followed to operations 372-4A, 374-4A, 376-4A to return the allocations to those that previous yielded the income of 65 (i.e., an allocation of 32/48/20). Then, the method ends at operation 390-4A.

In the illustration of FIG. 32B, the income calculation 311-4B returns a value of 70 and the production tracking operation 400-4B returns the values shown in operation 314-4B. Since the income of 70 is greater than the previous income of 65, the method follows the “yes” branch from operation 312-4B to operation 316-4B. However, since operation 316-4B determines that the Medium Discount units did not sell out, the “No” branch is followed to operation 318-4B to set p=0, and then to operations 320-4B, 322-4B, 324-4B to keep the allocation the same (32/48/20). Next, the value oft is incremented from 4 to 5 in operation 326-4B, and then the method loops back around. Ultimately, the method will resolve to either the scenario of FIG. 32A or the scenario of FIG. 32C to end at operation 390-4B.

In the illustration of FIG. 32C, the income calculation 311-4C returns a value of 65. Since the income of 65 is not greater than the previous income of 65, the method follows the “No” branch from operation 312-4C to operation 370-4C. Since operation 370-4C determines that the current income of 65 is equal to the previous income of 65, then the “Yes” branch is followed to end the method at operation 390-4C.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media that is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
receiving, from each of a plurality of service provider computing devices, an allotment of services available at a discount from a service provider, wherein the allotment of services identifies the name of the service provider, a parameter describing the services offered by the service provider, a price discount for the offered services, and a time period during which the price discount is applicable to receiving the offered services;
receiving, from a customer computing device, a query identifying a targeted parameter describing a targeted service;
transmitting, to the customer computing device, a graphical user interface for displaying the name of a service provider, from among the allotments of services received from the plurality of service provider computing devices, identified in one of the allotments of services in which the parameter describing offered services matches the targeted parameter of the targeted service;
receiving input from the customer computing device identifying, from among the service providers displayed in the graphical user interface, a selected service provider and a selected time period during which a selected price discount is applicable to the provision of the offered services, wherein the input from the customer computing device further identifies the customer and a total prepaid purchase amount of the selected offered services to be prepaid by the customer;
receiving a prepayment initiated from the customer computing device for the total prepaid purchase amount of the selected offered service less the selected price discount that is applicable to the provision of the selected offered services during the selected time period;
storing a voucher that identifies the customer, the selected service provider, the selected time period during which the selected price discount is applicable to the rendering of the selected offered services, and the total prepaid purchase amount of the selected offered services for which prepayment has been received;
transmitting a voucher notification to the service provider computing device of the selected service provider, wherein the voucher notification identifies the customer, the selected time period during which the selected price discount is applicable to the rendering of the selected offered services, and the total prepaid purchase amount of the voucher, and;
receiving an invoice from the service provider computing device of the selected service provider after the service provider has rendered services to the customer identified in the voucher notification, wherein the invoice identifies the service provider that rendered services to the customer, the customer, an actual purchase amount of the offered services, and a time at which the customer received the services;
determining whether the service provider, the customer, and the time identified in the invoice match the service provider, the customer, and the time identified in the stored voucher; and
initiating payment to the service provider in response to receiving the invoice and reaching a positive determination that the service provider, the customer, and the time identified in the invoice match the service provider, the customer, and the time identified in the stored voucher.

2. The computer program product of claim 1, the operations further comprising:
providing a service provider interface that is accessible over a wide area network, wherein the service provider interface is accessible to a service provider computing device in response to authentication of the service provider, and wherein the allotment of service is received from the service provider computing device through the service provider interface; and
providing a customer interface that is accessible over a wide area network, wherein the customer interface is accessible to a customer computing device in response to authentication of the customer, and wherein the input is received from the customer computing device through the customer interface.

3. The computer program product of claim 1, wherein receiving, from each of a plurality of service provider computing devices, an allotment of services available at a discount from the service provider, includes periodically receiving, from each of the plurality of service provider computing devices, an updated allotment of services available at a discount from the service provider.

4. The computer program product of claim 1, wherein the allotment of services received from one or more of the service provider computing devices identifies multiple price discounts for the offered services, wherein each of the multiple price discounts is identified with a unique time period during which the price discount is applicable to a purchase of the offered services.

5. The computer program product of claim 1, wherein the query from the customer computing device further identifies a designated location and a maximum distance, and wherein the graphical user interface displays the name of a given service provider only in response to the given service provider having a location that is less than the maximum distance from the designated location.

6. The computer program product of claim 1, wherein the query from the customer computing device further identifies a selected geographical area, and wherein the graphical user interface does not display the name of a given service provider in response to the given service provider having a location that is not within the selected geographical area.

7. The computer program product of claim 1, wherein the graphical user interface displays a map, wherein the map displays, for each of the offered services that satisfy the one or more parameter of the targeted service, an icon positioned on the map to indicate the location of the service provider identified in the allotment of services in association with the offered services.

8. The computer program product of claim 7, wherein, for each of the offered services that satisfy the one or more parameter of the targeted service, the icon includes one or more visual indicator of the price discount identified in an allotment of services in association with the offered services.

9. The computer program product of claim 8, wherein the one or more visual indicator of the price discount includes one or more colored borders around the icon, where each color is identified with a given price discount.

10. The computer program product of claim 1, wherein the allotment of services further includes a total quantity of units of the offered services qualifying for the price discount, wherein the input from the customer computing device identifies a requested quantity of units of the offered services, and wherein the voucher identifies a reserved quantity of units of the offered services for which prepayment has been received, the operations further comprising:
tracking an available quantity of units by subtracting any reserved quantity of units from the total quantity of units; and
preventing prepayment from the customer computing device in response to the requested number of units exceeding the available quantity of units.

11. The computer program product of claim 10, wherein the one or more visual indicator of the price discount includes an icon that is made to blink in response to the available quantity of units being less that a predetermined threshold quantity of units.

12. The computer program product of claim 10, wherein the service provider offers restaurant services, and wherein the units of the offered services are seats, tables or rooms.

13. The computer program product of claim 1, the operations further comprising:
transmitting, to the customer computing device, a prepayment code in response to receiving prepayment from the customer, wherein payment to the service provider for the prepaid services is contingent upon the received invoice including the prepayment code.

14. The computer program product of claim 1, the operations further comprising:
transmitting, to the customer computing device, a transaction summary in response to receiving prepayment from the customer, wherein the transaction summary includes a prepayment code, the selected service provider, the selected time period during which the selected price discount is applicable to the rendering of the selected offered services, and the total prepaid purchase amount of the selected offered services for which prepayment has been received.

15. The computer program product of claim 1, the operations further comprising:
receiving input from the customer computing device requesting cancellation of a specific stored voucher that identifies the customer;
canceling the specific stored voucher and providing credit to the customer in an amount of the prepayment less a cancellation fee; and
transmitting a cancellation message to the service provider computing device of the selected service provider, wherein the cancellation message identifies the customer and the selected time period of the selected offered services that are being canceled.

16. The computer program product of claim 1, wherein the payment initiated to the service provider is in an amount that is based on the total prepaid purchase amount.

17. The computer program product of claim 1, wherein the service provider offers restaurant services, and wherein the parameter describing the services includes a cuisine.

18. The computer program product of claim 1, wherein receiving, from a customer computing device, a query identifying a targeted parameter describing a targeted service, includes receiving, from the customer computing device, a query identifying a plurality of targeted parameters describing a targeted service.

19. The computer program product of claim 1, wherein the graphical user interface includes the names of a plurality of service providers, from among the allotments of services received from the plurality of service provider computing devices, identified in the allotments of services in which the parameter describing offered services matches the targeted parameter of the targeted service.

20. The computer program product of claim 1, wherein receiving, from a customer computing device, a query identifying a targeted parameter describing a targeted service, includes receiving, from the customer computing device, a query identifying a maximum discount and a given time of day, and wherein the graphical user interface includes the names of a plurality of service providers, from among the allotments of services received from the plurality of service provider computing devices, identified in the allotments of services in which a maximum discount is available at the given time of day.

21. A computer program product comprising a non-volatile computer readable medium and non-transitory program instructions embodied therein, the program instructions being configured to be executable by a processor to cause the processor to perform operations comprising:
receiving, from each of a plurality of service provider computing devices, an allotment of services available at a discount from a service provider, wherein the allotment of services identifies the name of the service provider, a parameter describing the services offered by the service provider, a plurality of price discounts for the offered services, and a time period during which each price discount is applicable to receiving the offered services;
receiving, from a customer computing device, a query identifying a targeted parameter describing a targeted service;
transmitting, to the customer computing device, a graphical user interface for displaying the name of a service provider, from among the allotments of services received from the plurality of service provider computing devices, identified in one of the allotments of services in which the parameter describing offered services matches the targeted parameter of the targeted service;
receiving input from the customer computing device identifying a selected service provider from among the service providers displayed in the graphical user interface, a customer and a total prepaid purchase amount of the offered services of the selected service provider to be prepaid by the customer;
receiving a prepayment initiated from the customer computing device for the total prepaid purchase amount of the offered services of the selected service provider, wherein a prepayment code is associated with each prepayment;
storing a voucher that identifies the customer, the selected service provider, the total prepaid purchase amount of the selected offered services for which prepayment has been received, the prepayment code, a plurality of price discounts, and a unique time period associated with each price discount, wherein each price discount is applicable to the purchase of offered services during the time period associated with the price discount;
transmitting a voucher notification to the service provider computing device of the selected service provider, wherein the voucher notification identifies, for a given voucher, the total prepaid purchase amount of the selected offered services for which prepayment has been received, the plurality of price discounts, and the unique time period associated with each price discount;
receiving an invoice from the service provider computing device of the selected service provider after the service provider has rendered services to the customer identified in the voucher notification, wherein the invoice includes the prepayment code;
initiating payment to the service provider in response to receiving the invoice and reaching a positive determination that the prepayment code identified in the invoice is a valid prepayment code.

22. The computer program product of claim 21, wherein the invoice further identifies a time at which the customer received services from the service provider and a discount that was applied to the actual purchase amount.

23. The computer program product of claim 22, further comprising:
determining whether the discount and the time identified in the invoice match a given one of the price discounts and the unique time period associated with the given price discount in the stored voucher, wherein payment to the service provider is initiated in response to reaching the positive determination and reaching a further positive determination that the discount and the time identified in the invoice match a given one of the price discounts and the unique time period associated with the given price discount in the stored voucher.

24. The computer program product of claim 21, wherein a parameter describing the services offered by at least one of the service providers includes take-out food preparation and/or food delivery services.

25. A computer program product comprising a non-volatile computer readable medium and non-transitory program instructions embodied therein, the program instructions being configured to be executable by a processor to cause the processor to perform operations comprising:
identifying a total number of units of service available from a service provider for sale at a discount;
setting a plurality of time periods over which the identified number of units of service are available, wherein the plurality of time periods includes a first time period;
establishing, for each of the time periods, an initial distribution of the total number of units among three discount levels, wherein the initial distribution includes a first number of units available at a first discount, a second number of units available at a second discount, and a third number of units available at a third discount, wherein the first discount is greater than the second discount, and wherein the second discount is greater than the third discount; and
during a plurality of instances of the first time period:
tracking a number of units of service that are sold at each discount level during the latest instance of the first time period;
calculating an amount of income received from the sale of units of services during the latest instance of the first time period; and
for an immediately subsequent instance of the time period:
reducing the number of units available at the first discount by a predetermined percentage and increasing the number of units available at the second discount to include the number of units that are no longer available at the first discount in response to (1) the amount of income during the latest instance of the first time period being greater than the amount income during the previous instance of the first time period, (2) the units available at the first discount and the second discount being sold out during the time period, and (3) the number of units available at the first discount being greater than a predetermined minimum number of units;
reducing the number of units available at the second discount by the predetermined percentage and increasing the number of units available at the third discount to include the number of units that are no longer available at the second discount in response to (1) the amount of income during the latest instance of the first time period being greater than the amount income during the immediately prior instance of the first time period, (2) the units available at the first discount and the second discount being sold out during more than a preset number of instances of the time period and (3) the number of units available at the third discount being less than a predetermined maximum number of units; and
making no change in the number of units available at the first discount, the number of units available at the second discount, and the number of units available at the third discount for an immediately subsequent instance of the time period in response to (1) the amount of income during the latest instance of the first time period being greater than the amount income during the previous instance of the first time period, and (2) the units available at the first discount and the second discount not being sold out during the latest instance of the time period.

26. The computer program product of claim 25, further comprising:
during the plurality of instances of the first time period:
for an immediately subsequent instance of the time period, returning the number of units available at the first discount, the number of units available at the second discount, and the number of units available at the third discount to the amounts available in an immediately prior instance of the time period in response to (1) the amount of income during the latest instance of the first time period being less than the amount of income during the immediately prior instance of the time period.

27. The computer program product of claim 25, further comprising:
during the plurality of instances of the first time period:
for an immediately subsequent instance of the time period, making no change in the number of units available at the first discount, the number of units available at the second discount, and the number of units available at the third discount for a subsequent time period in response to (1) the amount of income during the latest instance of the first time period being equal to the amount of income during the immediately prior instance of the time period.

28. The computer program product of claim 25, wherein each of the time periods is a range of time during a period of a day, and wherein each instance of the first time period is a range of time during a given day.

29. The computer program product of claim 25, wherein the plurality of time periods includes a second time period;
during a plurality of instances of the second time period:
tracking a number of units of service that are sold at each discount level during the latest instance of the second time period;
calculating an amount of income received from the sale of units of services during the latest instance of the second time period;
for an immediately subsequent instance of the time period:
reducing the number of units available at the first discount by a predetermined percentage and increasing the number of units available at the second discount to include the number of units that are no longer available at the first discount in response to (1) the amount of income during the latest instance of the second time period being greater than the amount income during the previous instance of the second time period, (2) the units available at the first discount and the second discount being sold out during the time period, and (3) the number of units available at the first discount being greater than a predetermined minimum number of units;
reducing the number of units available at the second discount by the predetermined percentage and increasing the number of units available at the third discount to include the number of units that are no longer available at the second discount in response to (1) the amount of income during the latest instance of the second time period being greater than the amount income during the immediately prior instance of the second time period, (2) the units available at the first discount and the second discount being sold out during more than a preset number of instances of the time period and (3) the number of units available at the third discount being less than a predetermined maximum number of units; and
making no change in the number of units available at the first discount, the number of units available at the second discount, and the number of units available at the third discount for an immediately subsequent instance of the time period in response to (1) the amount of income during the latest instance of the second time period being greater than the amount income during the previous instance of the second time period, and (2) the units available at the first discount and the second discount not being sold out during the latest instance of the time period.

30. A computer program product comprising a non-volatile computer readable medium and non-transitory program instructions embodied therein, the program instructions being configured to be executable by a processor to cause the processor to perform operations comprising:
receiving, from each of a plurality of service provider computing devices, an allotment of services available at a discount from a service provider, wherein the allotment of services identifies the name of the service provider, a parameter describing the services offered by the service provider, a price discount for the offered services, and a time period during which the price discount is applicable to receiving the offered services;
receiving, from a customer computing device, a query identifying a targeted parameter describing a targeted service;
providing, to the customer computing device, a graphical user interface for displaying the name of a service provider, from among the allotments of services received from the plurality of service provider computing devices, identified in one of the allotments of services in which the parameter describing offered services matches the targeted parameter of the targeted service;
receiving input from the customer computing device identifying, from among the service providers displayed in the graphical user interface, a selected service provider and a selected time associated with a selected price discount applicable to the provision of the offered services;
receiving input from the customer computing device initiating a payment to be credited to a prepaid account associated with the customer;
receiving an invoice from the service provider computing device of the selected service provider after the service provider has rendered services to the customer identified in the voucher notification, wherein the invoice identifies the service provider that rendered services to the customer, the customer, and an actual purchase amount of the offered services;
removing the actual purchase amount from a prepaid account associated with the customer; and
initiating payment to the service provider in response to receiving the invoice and removing the actual purchase amount from the prepaid account associated with the customer.
